(19) United States
(12) Patent Application Publication
(10) Pub. No.: US 2013/0248768 A1
(43) Pub. Date: Sep. 26, 2013

(54) METHOD AND SYSTEM FOR PRODUCING SYNGAS

(71) Applicant: Oron ZACHAR, Tel-Aviv (IL)

(72) Inventor: Oron ZACHAR, Tel-Aviv (IL)

(21) Appl. No.: 13/751,171

(22) Filed: Jan. 28, 2013

Related U.S. Application Data
(63) Continuation of application No. PCT/IB2010/053739, filed on Aug. 19, 2010.

(51) Int. Cl. C01B 3/34

(52) U.S. Cl. CPC C01B 3/34
USPC 252/373

(57) ABSTRACT

Embodiments of the present invention relate to an apparatus and method for producing syngas where a metal vapor participates in a syngas-producing chemical reaction between steam, methane and optionally carbon dioxide. In some embodiments, the method may be carried out, or the apparatus may be configured so that there is substantially no net production of an oxide of the metal. The syngas may be generated in the context of methanol production, of steam reforming or in any other context. Methods and apparatus for handling the products and by-products of the chemical reaction are disclosed herein.

### CROSS-REFERENCE TO RELATED APPLICATIONS

This patent application is a continuation of PCT/IB2010/053739 filed on Aug. 18, 2010 and incorporated herein by reference in its entirety.

### FIELD OF THE INVENTION

The present invention relates to methods and apparatus for producing synthetic gas (syngas).

### BACKGROUND AND RELATED ART

Embodiments of the present invention relates to methods and apparatus for producing synthetic gas (syngas) for any purpose. In particular, embodiments of the present invention relate to methods and apparatus for chemically converting methane, steam and optionally carbon dioxide into a mixture of carbon monoxide and hydrogen.

According to Wikipedia,
Syngas (from synthesis gas) is the name given to a gas mixture that contains varying amounts of carbon monoxide and hydrogen. Examples of production methods include steam reforming of natural gas or liquid hydrocarbons to produce hydrogen, the gasification of coal biomass, and in some types of waste-to-energy gasification facilities. The name comes from their use as intermediates in creating synthetic natural gas (SNG) and for producing ammonia or methanol. Syngas is also used as an intermediate in producing synthetic petroleum for use as afuel or lubricant via the Fischer-Tropsch process and previously the Mobil methanol to gasoline process.
Syngas consists primarily of hydrogen, carbon monoxide, and very often some carbon dioxide, and has less than half the energy density of natural gas. Syngas is combustible and often used as a fuel source or as an intermediate for the production of other chemicals.

Methanol or dimethyl ether (DME) is the simplest liquid oxygenated hydrocarbon, differing from methane (CH₄) by a single additional oxygen atom. Natural gas (CH₄) is presently the primary feedstock hydrocarbon source for industrial production of methanol. Syngas is produced in an intermediate step of this industrial process. Although methanol is readily produced from natural gas, many conventional methods that entail conversion (reforming) of coal and subsequently natural gas to synthetic gas (Syngas) (a mixture of H₂ and CO) are highly energy consuming and produce large amount of CO₂ as a by-product.

Many conventional industrial techniques rely on solid catalysts (for example, ceramic catalysts or metallic-oxide catalysts) to produce syngas, for the purpose of manufacturing methanol. Towards this end, many industrial techniques for producing syngas are carried out in a fixed beds or fluidized beds. In many implementations, the solid catalysts may be present as very small particles or pellets that behave as free-flowing solid particulate matter.

Recently, a different approach for producing syngas was described in PCT Patent Application PCT/IL2007/001576, publication number: WO/2008/050350, and PCT Patent Application PCT/IL2008/000964, publication number WO/2009/010959 (referred to below as “Yogev disclosures”) which both are incorporated by reference for all purposes as if fully set forth herein.

Rather than relying on a solid catalyst, the Yogev disclosure describes a process where metal reactant is introduced into the reaction chamber in liquid form (for example, as droplets or as a spray).

One by-product of the chemical reaction described by Yogev is an oxide of the metal reactant. Yogev discloses a so-called metal regenerating unit where the reactant metal is regenerated from the metal oxide by-product. The regenerated metal may be re-introduced back into the syngas reaction chamber. Thus, metal atoms (i.e. in any chemical form) may pass through the reaction chamber a number of times.

The following patent documents and non-patent publications describe potentially relevant background art, and are each incorporated herein by reference in their entirety:
[1] Moulijn, J., Makkee, M., van Diepen, A., Chemical Process Technology, John Wiley & Sons Ltd, England
[2] Dybkjaer, I., Tubular reforming and autothermal reforming of natural gas—an overview of available processes, Fuel. Proc. Tech., (1995).
[3] PCT Patent Application PCT/IL2007/001576, publication number: WO/2008/050350, of Yogev et. al.
[4] PCT Patent Application PCT/IL2008/000964, publication number WO/2009/010959, of Yogev et. al.
[5] U.S. patent application Ser. No. 12/142,467, of Olah George et al. publication No. 2009/0030240.
[6] PCT patent application No. PCT/NL2006/000283.
[7] PCT patent application No. PCT/NL2006/000283, of Larnholm Per-Reidar and Schook Robert, publication No. WO/2006/132527.
[8] U.S. Pat. No. 6,852,668 of de Lasa et al.
[9] U.S. Pat. No. 5,876,679 of D'Acierno et al.
[10] PCT Patent Application PCT/GB1993/000329, publication number: WO/1993/015999.

### SUMMARY OF EMBODIMENTS

Some embodiments of the disclosed subject-matter relate to a syngas production technique and related apparatus whereby liquid-phase and/or gaseous-phase metal reactant chemically reacts with gaseous CH₄, H₂O (and optionally CO₂) such that metallic-oxide by-product is not substantially produced by the syngas-producing chemical reaction. Although not a limitation, in some embodiments this may allow re-cycling of metal reactant in a manner that obviates the need to chemically re-generate metal reactant from metallic oxide.

Although certainly not a limitation, investigations by the present inventor have indicated that it is possible to achieve the ‘substantial absence of metallic-oxide by-product formation’ conditions when the CH₄:H₂O:CO₂ input feedstock ratio is substantially equal to 3:2:1 or substantially equal to 1:1:0 or to any other feedstock ration that facilitates.

Some embodiments of the disclosed subject-matter relate to a syngas production technique and related apparatus whereby liquid-phase or gaseous-phase metal reactant chemically reacts with gaseous CH₄, CO₂ and H₂O in a reaction chamber such that the CH₄:H₂O:CO₂ input feedstock ratio is substantially equal to 3:2:1.

Although certain embodiments relate to ‘minimal metallic-oxide by-product’ industrial processes and related apparatus, other embodiments may relate to process and apparatus where the level of metallic-oxide by-product produced in the syngas-generating chemical reaction is higher, or even much higher than what is obtained in the ‘minimal metallic-oxide by-product’ embodiments.

Some embodiments of the disclosed subject-matter relate to a ‘CO₂ consuming” combination of industrial process (and related apparatus) whereby two industrial processes are carried out: (i) a first industrial process whereby CH₄, CO₂ and H₂O are chemically reacted, within a reaction chamber, with liquid and/or gaseous phase metallic reactant to obtain syngas and optionally an oxide of the metal reactant as a by-product; (ii) a second industrial process whereby a substantial majority of atoms (i.e. either as pure metal or as a metal-oxide or in any other form) of the metallic reactant (i.e. at least 60% or at least 70% or at least 80% or at least 90% or at least 95%) which leave the reaction chamber are subsequently re-introduced into the reaction chamber in a ‘re-cycling’ stream that is mostly free of oxides of the metal reactant. In some embodiments, the combination of these two industrial processes is net CO₂ consuming—i.e. more CO₂ is consumed by the combination of these two industrial processes than is produced by these two industrial processes.

As noted above, in some embodiments, the CH₄:H₂O:CO₂ input feedstock ratio is substantially equal to 3:2:1. In yet other embodiments, CH₄:H₂O:CO₂ input feedstock ratio is substantially equal to 1:2:1. In yet other embodiments, CH₄:H₂O:CO₂ input feedstock ratio is substantially equal to 1:1:0. In yet other embodiments, other input feedstock ratios of the non-metallic gasses and other stoichiometries (i.e. other than those explicitly listed) may be used.

In various embodiments, it may be useful to carry out the chemical reaction that produces syngas at a temperature at or near the boiling point of the metal reactant—for example, at a temperature of about 850 degrees for Zinc metal.

A method of syngas production, according to some embodiments, comprises the step of chemically reacting a mixture of vapor of a metal, CH₄, H₂O, and optionally CO₂ to produce syngas substantially without net production of a non-transient oxide of the metal.

In some embodiments, the chemically-reacting mixture includes CO₂.

In some embodiments (for example, related to steam reforming), CO₂ is substantially absent from the chemically-reacting mixture.

In some embodiments, only trace amounts of the oxide of the metal are produced by the chemical reaction such that a ratio between: i. a number of moles of metal oxide produced by the chemical reaction; and ii. a number of moles of CO of the syngas produced by the chemical reaction, is a mole-ratio value that is at most 0.12 or at most 0.1 or at most 0.07 or at most 0.05 or at most 0.03 or at most 0.02 or at most 0.01 or at most 0.005 or at most 0.001 or at most 0.0005 or at most 0.0001.

In some embodiments, the chemical reaction is carried out in a reaction chamber into which the CH₄, H₂O and CO₂ are fed at an input ratio or input feedstock ratio that is substantially equal to 3:2:1 or is substantially equal to 1:1:0 or is substantially equal to 1:2:1. For example, the input ratio may be equal to 3:2:1 within a tolerance that is at most 12% or at most 10% or at most 5% or at most 1%.

A method of facilitating the production of syngas, according to some embodiments, comprises: a. chemically reacting, within a reaction chamber, a reaction mixture of vapor of a metal, CH₄, H₂O, and optionally CO₂ to produce syngas; b. exporting, from the reaction chamber, an export mixture including the syngas and the metal vapor; c. outside of the reaction chamber, cooling the export mixture to condense metal vapor into a metal liquid; and d. returning the metal liquid derived from the cooling process into the reaction chamber.

In some embodiments, the chemically-reacting mixture includes CO₂.

In some embodiments (for example, related to steam reforming), CO₂ is substantially absent from the chemically-reacting mixture.

In some embodiments, i. the cooling of step (c) condenses the vapor metal into a mist of gas-phase-suspended liquid droplets of metal; ii. the method further comprises the demisting the liquid droplets to effect a mist-gas separation operation and to obtain non-gas-suspended liquid; and iii. the returning of step (d) includes returning the non-gas-suspended liquid.

In some embodiments, the CH₄, H₂O and CO₂ are fed into the reaction chamber at an input ratio substantially equal to 3:2:1 and/or substantially equal to 1:1:0 and/or the chemical reaction of step (a) is a reaction that substantially does not generate net production of oxide of the metal in proportion to the quantities of CO₂ and H₂O gas fed into the reaction chamber.

In some embodiments, the chemical reaction of step (a) is a reaction that generates significant quantities an oxide of the metal (i.e. at any quantity—for example, above trace quantities or significantly above trace quantities).

In some embodiments, i) the exported mixture includes gas-suspended particles of the oxide of the metal; ii) the gas-suspended aerosol particles are separated from the syngas and externally regenerated outside of the reaction chamber to obtain re-generated metal; and iii) the externally re-generated metal is returned to the reaction chamber and re-vaporized.

In some embodiments, a majority of metal that is exported from the reaction chamber is subsequently returned back to the reaction chamber and re-vaporized.

A method of facilitating the production of syngas, according to some embodiments, a. chemically reacting a reaction mixture of vapor of a metal, CH₄, H₂O, and optionally CO₂ to produce both syngas and an oxide of the metal; b. subjecting an export mixture including the syngas and the metal vapor to a reaction-chamber export operation; c. cooling the exported mixture to condense metal vapor into a liquid-phase metal; and d. re-heating the liquid-phase metal to re-convert the liquid-phase metal into metal vapor; and e. subjecting the re-heated metal that is now vapor to the chemical reaction of step (a) to produce additional syngas.

In some embodiments, the chemically-reacting mixture includes CO₂.

In some embodiments (for example, related to steam reforming), CO₂ is substantially absent from the chemically-reacting mixture.

In some embodiments, the syngas-producing chemical reaction of step (a) is carried out at a temperature within 90 degrees Celsius of a boiling temperature of the metal at the pressure of the chemical reaction.

In some embodiments, in step (c), the export mixture is cooled by at least 100 degrees Celsius or by at least 150 degrees Celsius or by at least 200 degrees Celsius or by at least 250 degrees Celsius or by at least 300 degrees Celsius.

In some embodiments, the cooling process of step (c) is a limited cooling process such that the gases are only cooled to a temperature above the water boiling at the operating pressure.

In some embodiments, the cooling process of step (c) is a limited cooling process such that the gases are only cooled to a temperature above the water boiling at the operating pressure.

A method of facilitating the production of syngas, in some embodiments, comprises: effecting an industrial process whereby: i. syngas is produced in a reaction chamber by a chemical reaction involving vapor of a metal, CH₄, H₂O, and optionally CO₂; and ii. metal re-cycling operations are conducted so that atoms of the metal leaving the reaction chamber are re-cycled back into the reaction chamber, wherein the industrial process is carried out such that a majority of the re-cycled atoms of metal leaves the reaction chamber as non-oxidized metal.

In some embodiments, the chemically-reacting mixture includes CO₂.

In some embodiments (for example, related to steam reforming), CO₂ is substantially absent from the chemically-reacting mixture.

A method of facilitating the production of syngas, in some embodiments, comprises: Effecting an industrial process whereby: i. syngas is produced in a reaction chamber by a chemical reaction involving vapor of a metal, CH₄, H₂O, and optionally CO₂; ii. metal re-cycling operations are conducted so that atoms of the metal leaving the reaction chamber are re-cycled back into the reaction chamber, wherein the industrial process is carried out such that a majority of the re-cycled atoms of metal leaves the reaction chamber as a mist of metal and/or in gaseous form.

In some embodiments, the chemically-reacting mixture includes CO₂.

In some embodiments (for example, related to steam reforming), CO₂ is substantially absent from the chemically-reacting mixture.

In some embodiments, the CH₄, H₂O and CO₂ is introduced into the reaction chamber at an input feedstock ratio substantially equal to 3:2:1 or at an input feedstock ratio substantially equal to 1:1:0 or at an input feedstock ratio substantially equal to 1:2:1.

A method of generating syngas in a manner useful for reducing production of metal oxide as a byproduct, in some embodiments, comprises: a. introducing CH₄, H₂O and CO₂ into a reaction chamber at an input ratio that is substantially equal to 3:2:1, thereby obtaining a mixture of non-metallic gases; and b. chemically reacting, within the reaction chamber, gases of the non-metallic gas mixture with vapour of a metal to produce syngas.

For example, the input ratio may be equal to 3:2:1 within a tolerance that is at most 12% or at most 10% or at most 5% or at most 1%.

A method of generating syngas in a manner useful for reducing production of metal oxide as a byproduct, in some embodiments, comprises: a. introducing CH₄, H₂O and optionally CO₂ into a reaction chamber at an input ratio that is substantially equal to 1:1:0, thereby obtaining a mixture of non-metallic gases; and b. chemically reacting, within the reaction chamber, gases of the non-metallic gas mixture with vapour of a metal to produce syngas.

For example, the input ratio may be equal to 1:1:0 within a tolerance that is at most 12% or at most 10% or at most 5% or at most 1%.

A method of syngas production, in some embodiments, comprises: effecting an industrial process where: i) a gas mixture of CH₄, CO₂, H₂O and metal vapor is chemically reacted to produce syngas; ii) substantially all metal oxide that is produced during the chemical reaction is regenerated back into non-oxidized metal; and iii) the combination of the syngas production and the metal regenerating is net CO₂-consuming.

In some embodiments, the combination of the syngas production and the metal regenerating consumes at least 0.05 or at least 0.1 or at least 0.15 moles or at least 0.2 moles or at least 0.24 moles of CO₂ for every mole of CO generated.

In some embodiments, a majority (or a significant majority) of the metal regenerating is internal regeneration that is carried out within the same reaction chamber where the syngas-generating chemical reaction between the non-metallic gases and the metal occurs.

In some embodiments, at least some of the metal regenerating is external regeneration that is carried out outside of the reaction chamber where the syngas-generating chemical reaction between the non-metallic gases and the metal occurs.

In some embodiments, substantially all of the metal regenerating is internal regeneration that is carried out within the same reaction chamber where the syngas-generating chemical reaction between the non-metallic gases and the metal occurs.

In some embodiments, “substantially all metal oxide” of the phrase “substantially all metal oxide that is produced during the chemical reaction is regenerated back into non-oxidized metal” is defined as at least 88% or at least 90% or at least 95% or at least 97% or at least 99% or at least 99.5% or at least 99.9% of the metal oxide.

In some embodiments, the metal is selected from the group consisting of Zinc, Magnesium, Cadmium, and Strontium.

In some embodiments, the metal is Zinc.

In some embodiments, the metal has a boiling temperature between 800 and 1200 degrees Celsius at atmospheric pressure.

In some embodiments, the metal has a boiling temperature between 900 and 1100 degrees Celsius at atmospheric pressure.

In some embodiments, the syngas-producing chemical reaction involving the CH₄, CO₂ H₂O and the metal vapor is carried out at a temperature that is within 250 degrees or 200 degrees or 160 degrees or 100 degrees or 90 degrees or 80 degrees or 70 degrees or 60 degrees or 50 degrees or 40 degrees or 30 degrees or 20 degrees or 10 degrees Celsius of the boiling point temperature of the metal at the chemical-reaction temperature.

In some embodiments, within “X degrees of the boiling point” means below the boiling point and also within X degrees of the boiling point” of the boiling point.

Thus, the reaction may be carried out below the boiling point in some embodiments.

The reaction may be carried out above the boiling point in other embodiments.

In some embodiments, within “X degrees of the boiling point” means above the boiling point and also within X degrees of the boiling point” of the boiling point. the syngas-producing chemical reaction is carried out at pressure/temperature conditions such that a mass or molar ratio between gas-phase metal and non-gaseous phase metal is at least 0.03 or at least 0.05 or at least 0.1 or at least 0.15 or at least 0.2

A system for facilitating syngas production according to some embodiments comprises: A syngas producing unit, configured to receive a metal, CO2, CH4 and H2O so that a chemical reaction between vapor of the metal, CO2, CH4 and H2O 2O produces syngas, the syngas producing unit configured to receive the CO2, CH4 and H2O at an CH₄, H₂O and CO₂ input ratio that is substantially 3:2:1.

For example, the input ratio may be equal to 3:2:1 within a tolerance that is at most 12% or at most 10% or at most 5% or at most 1%.

A system for facilitating syngas production, according to some embodiments, comprises: a syngas producing unit, configured to receive a metal, H2O, CH4 and optionally CO2 so that a chemical reaction between vapor of the metal, H2O, CH4 and optionally CO2 produces syngas, the syngas producing unit configured to operate under reaction such that syngas is produced by the chemical reaction substantially without net production of an oxide of the metal.

A system for facilitating syngas production according to some embodiments comprises: a) a syngas producing unit, configured to receive a metal, H2O, CH4 and optionally CO2 so that a chemical reaction between vapor of the metal, H2O, CH4 and optionally CO2 produces syngas, the syngas producing unit include a gas outlet for letting out a gaseous outflow including metal vapor and syngas; b) a metal liquefaction unit configured to receive the gaseous outflow and to cool gases of the outflow to condense metal vapor into a metal liquid; and c) a conduit configured to return the metal liquid to the syngas producing unit.

In some embodiments, the system may further comprise a demister.

A system for facilitating syngas production, according to some embodiments, comprises: a) a syngas producing unit, configured to receive a metal, H2O, CH4 and optionally CO2 so that a chemical reaction between vapor of the metal, H2O, CH4 and optionally CO2 produces syngas, the syngas producing unit including one or more outlets via which material can be exported; and b) one or more external recycle loops configured to convey exported oxidized and/or non-oxidized metal out of the syngas producing unit and to re-introduce the exported metal back into the syngas producing unit such that substantially all of the exported metal is re-introduced back into the syngas producing unit, the external recycle loops configured to receive a majority of the exported metal as a metal vapor or as a mist of a metal.

A system for facilitating syngas production, according to some embodiments, comprises: a) a syngas producing unit, configured to receive a metal, H2O, CH4 and optionally CO2 so that a chemical reaction between vapor of the metal, H2O, CH4 and optionally CO2 produces syngas, the syngas producing unit including one or more outlets via which material can be exported; and h) one or more external recycle loops configured to convey exported oxidized and/or non-oxidized metal out of the syngas producing unit and to re-introduce the exported metal back into the syngas producing unit such that substantially all of the exported metal is re-introduced back into the syn as producing unit, the external recycle loops configured to receive a majority of the exported metal as a metal vapor or as a mist of a metal.

A system for facilitating syngas production comprising: a) a syngas producing unit, configured to receive a metal, CO2, CH4 and H2O so that a chemical reaction between vapor of the metal, CO2, CH4 and H2O produces syngas, the syngas producing unit including one or more outlets via which material can be exported; b) one or more external recycle loops configured to convey exported metal or metal oxide out of the syngas producing units and to re-introduce non-oxidized metal back into the syngas producing unit, wherein the syngas producing unit and the external recycle loops are operated such that: i) substantially all metal oxide that is produced during the chemical reaction is regenerated back into non-oxidized metal; and ii) the combination of the syngas production and the metal regenerating is net CO2-consuming.

A syngas production apparatus, in some embodiments, comprises (a) a syngas producing unit configured to receive metal, H2O, CH4 and optionally CO2 and to chemically react these non-metallic gases with gas-phase metal and/or a mist of the metal to produce syngas, the syngas producing unit including two outlets including a first outlet for out-flowing liquid and a second outlet for out-flowing gases and gas-suspended liquid or solid; (b) a metal-regenerating unit configured for regenerating metal from metal oxide produced in the syngas producing unit and exported from the syngas producing unit via the first outlet; (c) a condensing unit configured to (i) receive from the second outlet, a mixture of gaseous metal and non-metallic gases including syngas and (ii) to induce condensation of the gaseous metal into liquid-phase metal droplets suspended in the non-metallic gas as a mist; and (d) a demister for (i) receiving the mixture of the non-metallic gas and mist metal from the demister and (ii) separating the liquid-phase metal from the gas.

Some embodiments of the present invention relate to a syngas production apparatus including: (a) a syngas producing unit configured to receive CH₄, H₂O, and CO₂ and to chemically react these non-metallic gases with liquid-phase and/or gas-phase metal reactant to produce syngas, the syngas producing unit including two outlets (for example, at different elevations) including a first (for example, lower-elevation) outlet for out-flowing liquid and a second (for example, higher-elevation) outlet for out-flowing gases and gas-suspended liquid or solid; (b) a metal-regenerating unit configured for regenerating metal from metal oxide produced in the syngas producing unit and exported from the syngas producing unit via the first outlet; (c) a condensing unit configured to (i) receive from the second outlet, a mixture of gaseous metal reactant and non-metallic gases including syngas and (ii) to induce condensation of the gaseous metal reactant into liquid-phase metal reactant droplets suspended in the non-metallic gas as a mist; and (d) a demister for (i) receiving the mixture of the non-metallic gas and mist metal reactant from the demister and (ii) separating the liquid-phase droplets of metallic reactant mist from the non-metallic gases including syngas, and optionally (iii) separating also solid-phase particulates of metal-oxide reactant aerosol from the non-metallic gases including syngas.

In some embodiments, metal oxide solid particulate matter may exit the reaction chamber via the first outlet (for example, as small particles suspended in liquid metal exported from the reaction chamber) and/or via the second outlet (for example, as free-flowing particulate matter suspended in non-metallic gas exported from the reaction chamber to the condenser).

In some embodiments, gas-suspended small particles of metal-oxide exit the syngas producing unit, flow through the condenser while remaining suspended in the non-metallic gas, and then are separated from the gas in the demister. The demister may be configured to export two flow streams: (i) a liquid flow stream where small particles of metal oxide (i.e. oxide of the metallic reactant) are suspended in the liquid metal (e.g. flowing liquid metal) and (ii) a second flow stream of non-metallic gases.

Thus, in some embodiments, the liquid-phase flow stream thus may include metal-oxide material. It is possible to introduce this metal-oxide material (i.e. either by itself of together with non-oxidized metal) into one or more of the metal-regenerating units.

This may be any number of metal-regenerating units, and they may be cofigured in any manner. In one example, a first metal-regenerating unit is configured to regenerate metal-oxide which exits the syngas production unit via the first outlet and a second metal-regenerating unit is configured to regenerate metal-oxide which exits the via the second outlet and eventually arrives in the second metal-regenerating unit via the condenser and the demister. In another example, a given metal-regenerating unit may regenerate both metal-oxide that exits from the first outlet of the syngas production units as well as metal-oxide that exits from the second outlet of the syngas production unit.

In some embodiments, a method for producing syngas comprising the stages of: (a) providing a feedstock of ingredients into a syngas producing unit, wherein said ingredients includes CH₄ and at least one other ingredient selected from a group consisting of H₂O and CO₂; (b) providing a feedstock of at least one metal reactant into said syngas producing unit; (c) reacting, in said syngas producing unit, reactions of a mixture of said feedstock ingredients with said metal reactant; (d) demisting by letting out products of said reactions, wherein said products of said reactions include of syngas and metal reactant, into a demister, and separating most of the liquid of said metal from said products syngas; (e) recycling said metal by returning said liquid metal from said demister into said syngas producing unit; and (f) outputting remaining gaseous products from said syngas producing unit.

In some embodiments, further comprising the stages of: (g) maintaining a temperature of said syngas producing unit within 200° C. from the boiling temperature of said metal at a pressure in which said reaction is operated within said syngas producing unit, and thereby creating a significant portion of vapor of said metal; (h) letting out products of said reaction into a condenser; (i) condensing said vapor of said metal by cooling gas products within said condenser to a cooled temperature, wherein said cooled temperature is least 300° C. below said metal boiling temperature yet above the boiling temperature of water, so that said metal is liquefied while remaining products are maintained in a gaseous state, wherein said remaining products includes CO, H₂, H₂O, CO₂ and CH₄; and (j) letting out products of said condenser into said demisting demister.

In some embodiments, said metal is selected from a group consisting of metals having a boiling temperature within 900° C. of 1100° C. at atmospheric pressure.

In some embodiments, said metal is selected from a group consisting of metals having a boiling temperature within 900° C. of 1100° C. at atmospheric pressure.

In some embodiments, said syngas producing unit temperature is selected from a group consisting of a temperature within 160° C., a temperature within 140° C., a temperature within 120° C., a temperature within 100° C., a temperature within 80° C., a temperature within 70° C., a temperature within 60° C., a temperature within 50° C., a temperature within 40° C., a temperature within 30° C., a temperature within 20° C., and a temperature within 10° C. of the boiling temperature of said metal at the pressure in which said reaction is operated within syngas producing unit.

In some embodiments, said syngas producing unit temperature is selected from a group consisting of a temperature within 160° C., a temperature within 140° C., a temperature within 120° C., a temperature within 100° C., a temperature within 80° C., a temperature within 70° C., a temperature within 60° C., a temperature within 50° C., a temperature within 40° C., a temperature within 30° C., a temperature within 20° C., and a temperature within 10° C. a temperature within the boiling temperature of said metal at the pressure in which said reaction is operated within syngas producing unit.

In some embodiments, reactions of said metal reactant with said feedstock ingredients includes reacting H₂O with said metal to obtain H₂, metal-oxide and heat, reacting CO₂ with said metal, to obtain CO, metal-oxide and heat, and reacting CH₄ with said metal-oxide to obtain said metal, CO, and two H₂.

In some embodiments, said cooled temperature is selected from a group consisting of a temperature within 300° C. to 400° C., a temperature within 400° C. to 500° C., and a temperature within 500° C. to 600° C., from said metal boiling temperature at the pressure of operation of said condenser.

In some embodiments, a ratio of said feedstock ingredients of CH₄ to H₂O to CO₂ is maintained at near 3 to 2 to 1 (or at or near 1 to 2 to 1) within a deviation that is selected from a group consisting of at most 10% deviation, at most 5% deviation, and at most 1% deviation.

In some embodiments, said demister temperature is maintained at a temperature above the boiling temperature of water selected from a group consisting of a temperature within 20° C. to 50° C. above the boiling temperature of water, temperature within 100° C. to 200° C. above the boiling temperature of water, temperature within 200° C. to 300° C. above the boiling temperature of water, temperature within 300° C. to 400° C. above the boiling temperature of water, temperature within 400° C. to 500° C. above the boiling temperature of water.

In some embodiments, said outputting includes transferring remaining gaseous products from said syngas producing unit into a liquid fuel producing unit.

A system for producing syngas, according to some embodiments, comprises: a) a syngas producing unit having carbon dioxide inlet, water inlet, methane inlet, first metal inlet, a products flue outlet; and (b) a demister configured for receiving products from said products flue outlet, and for transferring liquid metal to said syngas producing unit through said first metal inlet, and wherein said demister has a syngas outlet.

In some embodiments, the system further comprises: (c) a fuel producing unit configured for receiving syngas from said syngas outlet of said demister.

In some embodiments, the system further comprises: a condenser configured for receiving a products mixture, including metal vapor and syngas from said products flue outlet and for transferring a mixture including syngas and metal liquid; and a demister configured for receiving a mixture of syngas and metal liquid from said condenser, configured for separating said metal liquid from said syngas, and for transferring liquid metal to said syngas producing unit through said first metal inlet, wherein said demister have a syngas outlet. †

In some embodiments, there is no metal oxide outlet and/or no liquid-phase outlet for a streaming liquid.

In some embodiments, the syngas producing unit has second metal inlet and metal oxide outlet.

In some embodiments, further comprising: (b) a metal regeneration unit configured for receiving metal oxide through a metal oxide outlet and for transferring liquid metal to said syngas producing unit through said first metal inlet; (c) a condenser configured for receiving metal vapor from a gas flue and for transferring syngas and metal liquid; (d) a demister configured for receiving syngas and metal liquid from condenser, and for transferring liquid metal to said syngas producing unit through said first metal inlet, wherein said demister has a syngas outlet; and (e) a fuel producing unit configured for receiving syngas through said syngas outlet.

In some embodiments, further comprising: (b) a metal regeneration unit configured for receiving metal oxide through a metal oxide outlet and for transferring liquid metal to said syngas producing unit; (c) a condenser configured for receiving a products mixture including metal vapor and syngas from said products flue outlet and for transferring syngas and metal liquid; (d) a demister configured for receiving a mixture of syngas and metal liquid from said condenser, configured for separating said metal liquid from said syngas, and for transferring liquid metal to said syngas producing unit through said first metal inlet, wherein said demister has a syngas outlet.

In some embodiments, further comprising: the syngas producing unit further includes: (i) a liquid metal sprinkling system mounted inside said syngas producing unit and/or (ii) at least one electric heater mounted inside said syngas producing unit.

In some embodiments, said syngas producing unit further includes: (iii) a ceramic insulator disposed on said syngas producing unit; and (iv) a metal casing disposed on said ceramic insulator.

A method for producing Syngas comprising: (a) providing a reaction chamber for producing Syngas; (b) providing an inflow of gaseous ingredient comprising of CH4 and at least one of H2O 2O and CO2 into said reaction chamber; (c) providing an inflow of at least one metal catalyst (hereby represented by “M”) into said reaction chamber; (d) reacting, in said reaction chamber, a mixture of gaseous ingredient comprising of CH4 and at least one of H2O and CO2 with a metal vapor, at a reaction chamber temperature within 90° C. from the boiling temperature of said metal at the pressure in which the reaction is operated within said reaction chamber; (e) letting out the gas products of said reaction into an intermediate chamber; (f) cooling said gas products within said intermediate chamber to a cooled temperature below said metal boiling temperature, so that said metal is liquefied while remaining gas products are maintained in a gaseous state; (g) returning said liquid metal from said intermediate chamber into said reaction chamber; (h) Transferring said remaining gaseous products from said intermediate chamber into another Syngas collection chamber; said metal has a boiling temperature within 200° C., or within 100° C., from 1000° C.

In some embodiments, said reaction chamber temperature is within 80° C., or within 70° C., or within 60° C., or within 50° C., or within 40° C., or within 30° C., or within 20° C., or within 10° C., from the boiling temperature of said metal at the pressure in which the reaction is operated within said reaction chamber.

In some embodiments, the reactions of said metal “M” with said gaseous ingredients comprise of reacting H2O 2O with M to obtain H2, MO and heat, reacting CO2 with M, to obtain CO, MO and heat, reacting CH4 with said MO to obtain M+CO+2H2;

In some embodiments, the cooled temperature is within 200° C., or within 100° C., from said metal boiling temperature.

In some embodiments, a ratio of said gaseous ingredient of said inflow is maintained substantially at (CH4:H2O:CO2)=(3:2:1).

A system, in some embodiments, comprises: (a) providing a system for producing Syngas, said system including: (i) a syngas producing unit, configured to receive an inflow of gaseous ingredient comprised of CO2, H2O, and CH4; and configured to receive a metal catalyst (hereby represented by “M”); (ii) wherein said Syngas producing unit comprise of: a container of a liquid of said metal; a reaction chamber, configured for receiving liquid of said metal from said container, and for receiving CH4 and at least one of H2O 2O and CO2, and having a gas outlet, configured for letting out a gaseous outflow of the products produced in the reaction chamber; and (iii) reacting said CO2 with said metal catalyst “M”, and said H2O with same metal catalyst, and said CH4 with an oxide of said metal catalyst to produce a gas comprising of H2 and CO Syngas component, (iv) a metal liquefaction unit, configured for receiving said gaseous outflow from said reaction chamber comprising of Syngas and vapor of said metal, and lowering its temperature to a cooled temperature level at which said metal component is liquefied; (iii) a conduit means of conducting the liquid of said metal from said liquefaction unit back into said reaction chamber; iv) a conduit means of conducting the Syngas from said liquefaction unit into a Syngas collection unit; and (b) means of controlling and maintaining said reaction chamber at a predetermined desired operation temperature; and (c) means of maintaining a predetermined stable molar ratio of said ingredients in the inflow of gaseous ingredient.

In some embodiments, said metal has a boiling temperature within 200° C., or within 100° C., from 1000° C.

According to some embodiments there is provided a method for producing syngas the method including the stages of: (a) providing a feedstock of ingredients into a syngas producing unit, wherein the ingredients includes CH₄ and at least one ingredient is selected from a group consisting of H₂O and CO₂; (b) providing a feedstock of at least one metal reactant into the syngas producing unit; (c) reacting, in the syngas producing unit, reactions of said mixture of the feedstock ingredients with the metal reactant; (d) demisting by letting out products of said reactions, wherein the products of the reactions comprise of syngas and metal reactant, into a demister, and separating liquid of the metal from the products syngas; (e) recycling the metal by returning the liquid metal from the demister into the syngas producing unit; and (f) outputting remaining gaseous products from the syngas producing unit.

According to further features of some embodiments of the method further including the stages of: outputting by transferring remaining gaseous products from the syngas producing unit into a fuel producing unit.

According to further features of some embodiments of the method further including the stages of: (g) maintaining a temperature of the syngas producing unit within 90° C. from the boiling temperature of the metal at the pressure in which the reaction is operated within the syngas producing unit, and thereby creating a significant portion of vapor of the metal; (h) letting out products of the reaction into a condenser; (i) condensing the vapor of the metal by cooling gas products within the condenser to a cooled temperature, wherein the cooled temperature is at least 300° C. below the metal boiling temperature, so that the metal vapor is substantially liquefied while remaining products are maintained in a gaseous state, wherein the remaining products include CO, H₂, H₂O, CO₂ and CH₄; and

(j) letting out all products of the condenser into the demisting demister.

According to still further features of the method of some embodiments of the metal is selected from a group consisting of a first metal having a boiling temperature within 100° C. of 1000° C. at atmospheric pressure, and a second metal having a boiling temperature within 200° C. of 1000° C. at atmospheric pressure.

According to still further features of the method of some embodiments of the syngas producing unit temperature is selected from a group consisting of a temperature within 80° C., a temperature within 70° C., a temperature within 60° C., a temperature within 50° C., a temperature within 40° C., a temperature within 30° C., 20° C., and a temperature within 10° C., from the boiling temperature of the metal at the pressure in which the reaction is operated within syngas producing unit.

According to still further features of the method of some embodiments a reactions of the metal reactant with the feedstock ingredients includes reacting H₂O with the metal to obtain H₂, metal-oxide and heat, reacting CO₂ with the metal, to obtain CO, metal-oxide and heat, and reacting CH₄ with the metal-oxide to obtain the metal, CO, and two H₂.

According to still further features of the method of some embodiments the metal reactant is selected from a group consisting of Zinc, Magnesium, Cadmium, and Strontium.

According to still further features of the method of some embodiments the cooled temperature is selected from a group consisting of a temperature within ranges of between 300° C. and 400° C., a temperature between 400° C. and 500° C., and a temperature between 500° C. and 600° C., from the metal boiling temperature at the pressure of operation of the condenser.

According to still further features of the method of some embodiments the ratio of the feedstock ingredients of CH₄ to H₂O to CO₂ is maintained at approximately 3 to 2 to 1 within a deviation that is selected from a group consisting of at most 10% deviation, at most 5% deviation, and at most 1% deviation.

According to still further features of the method of some embodiments the ratio of the feedstock ingredients of CH₄ to H₂O to CO₂ is maintained at approximately 1 to 2 to 1 within a deviation that is selected from a group consisting of at most 10% deviation, at most 5% deviation, and at most 1% deviation.

According to still further features of the method of some embodiments the demister temperature is maintained at least 100° C. above the boiling temperature of water; or preferably at least 200° C. above the boiling temperature of water; or preferably at least 300° C. above the boiling temperature of water; or preferably at least 400° C. above the boiling temperature of water; or preferably at least 500° C. above the boiling temperature of water.

According to the present invention a system for producing syngas is provided the system including: (a) a syngas producing unit having a carbon dioxide inlet, a water inlet, a methane inlet, a first metal inlet, and a gas flue.

According to further features of some embodiments the system for producing syngas further comprising (b) a demister configured for receiving gas from the gas flue, and for transferring liquid metal to the syngas producing unit through the first metal inlet, wherein the demister has a syngas outlet; and (c) a fuel producing unit configured for receiving syngas through the syngas outlet.

According to still further features of some embodiments the system for producing syngas further includes: (b) a condenser configured for receiving metal vapor from the gas flue and for transferring syngas and metal liquid; (c) a demister configured for receiving syngas and metal liquid from condenser, and for transferring liquid metal to the syngas producing unit through the first metal inlet, wherein the demister have a syngas outlet; and (d) a fuel producing unit configured for receiving syngas through the syngas outlet.

According to still further features of some embodiments the system for producing syngas contains no metal oxide outlet.

According to still further features of some embodiments the syngas producing unit has second metal inlet and metal oxide outlet.

According to still further features of some embodiments the system for producing syngas further includes: (b) a metal regeneration unit configured for receiving metal oxide through the metal oxide outlet and for transferring liquid metal to the syngas producing unit through the first metal inlet; (c) a condenser configured for receiving metal vapor from the gas flue and for transferring syngas and metal liquid; (d) a demister configured for receiving syngas and metal liquid from condenser, and for transferring liquid metal to the syngas producing unit through the first metal inlet, wherein the demister have a syngas outlet; and (e) a fuel producing unit configured for receiving syngas through the syngas outlet.

According to still further features of some embodiments the syngas producing unit includes: (i) a liquid metal sprinkling system mounted inside the syngas producing unit; and optionally (ii) at least one electric heater mounted inside the syngas producing unit.

According to still further features of some embodiments the syngas producing unit further including: (iii) a ceramic insulator disposed on the syngas producing unit; and (iv) a metal casing disposed on the ceramic insulator.

Additional objects and advantages of the invention will be set forth in part in the description which follows and, in part, will be obvious from the description, or may be learned by practice of the invention.

### BRIEF DESCRIPTION OF THE DRAWINGS

The invention is herein described, by way of example only, with reference to the accompanying drawings, wherein:

FIGS. 1-4 and 13 are flow charts of syngas production methods and related methods.

FIGS. 5-6, 10-12 and 14 are block diagrams describing apparatus for producing syngas and/or carrying out related processes.

FIG. 7 illustrates a plot of a numerical simulation of the reaction of some particular mixture (further elaborated on below) of natural gas, water (H₂O), and carbon dioxide (CO₂), without any additional metal reactant.

FIG. 8 illustrates the results of computer simulation of the Case-II reaction without Zn metal reactant.

FIG. 9 illustrates a plot of a simulation only for the catalytic reaction with Zinc.

### DETAILED DESCRIPTION OF EMBODIMENTS

The claims below will be better understood by referring to the present detailed description of example embodiments with reference to the figures. The description, embodiments and figures are not to be taken as limiting the scope of the claims. It should be understood that not every feature of the presently disclosed methods and apparatuses is necessary in every implementation. It should also be understood that throughout this disclosure, where a process or method is shown or described, the steps of the method may be performed in any order or simultaneously, unless it is clear from the context that one step depends on another being performed first. As used throughout this application, the word “may” is used in a permissive sense (i.e., meaning “having the potential to'), rather than the mandatory sense (i.e. meaning “must”).

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination.

Embodiments of the present invention relate to processes and apparatus and product for producing syngas by reacting a gas mixture including a vapor of a metal, methane, steam and optionally carbon dioxide. Embodiments of the present invention relate to relate to products obtained by carrying out any method described herein or a portion thereof. Embodiments of the present invention relate to novel mixtures including syngas and/or oxidized metal and/or non-oxidized metal.

In some non-limiting embodiments, the methods, apparatus and product may be useful in methanol production. Alternatively or additionally, the methods and apparatus and product may be useful in so-called steam reforming.

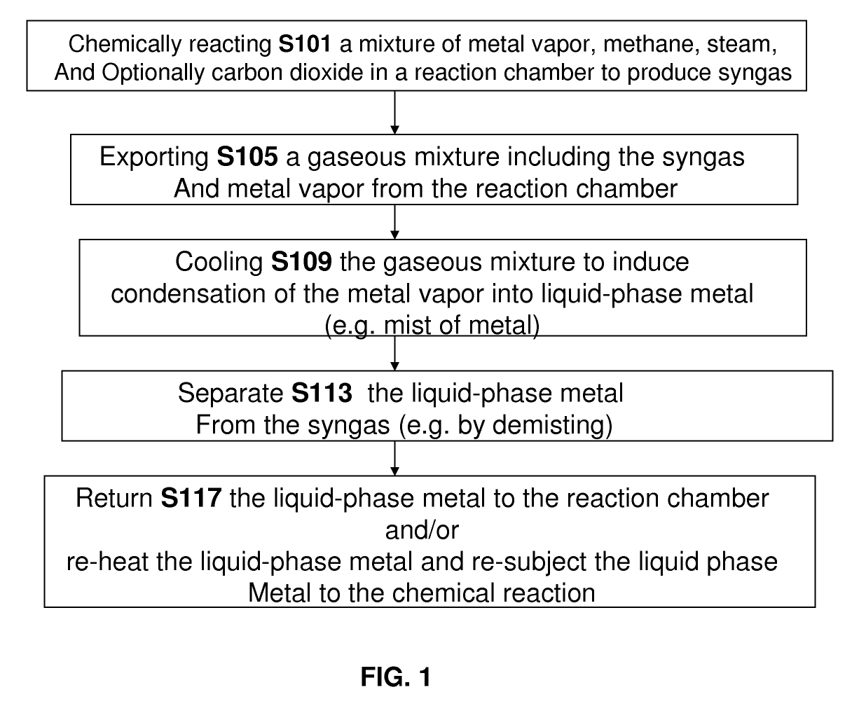

Some embodiments (see FIG. 1) relate to an external metal regeneration process whereby metal and/or an oxide thereof leaves a reaction chamber as part of a gas stream—for example, as gas-phase metal vapor and/or in the liquid phase (for example, as suspended droplets) and/or as solid particles suspended in the gas either directly or associated with gas-suspended liquid droplets. Liquid metal that is obtained from the exported gas stream may be returned to the reaction chamber and recycled. The recycled returned metal may be vaporized (e.g. in the reaction chamber) and, once again, participate in a syngas-producing chemical reaction with methane, carbon dioxide, and steam.

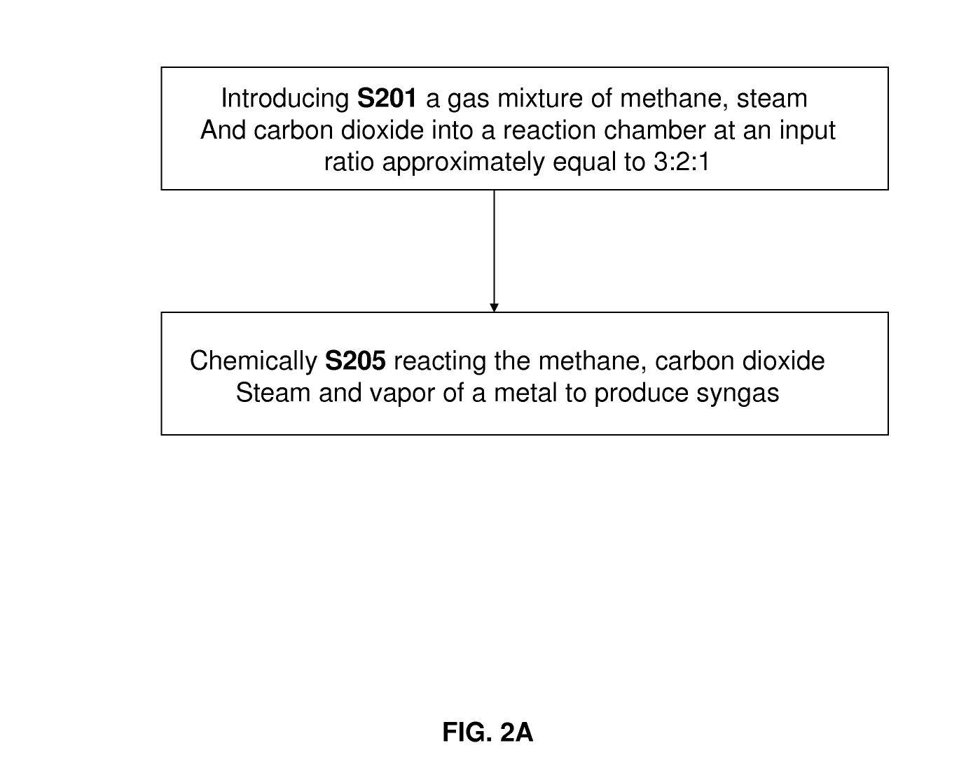

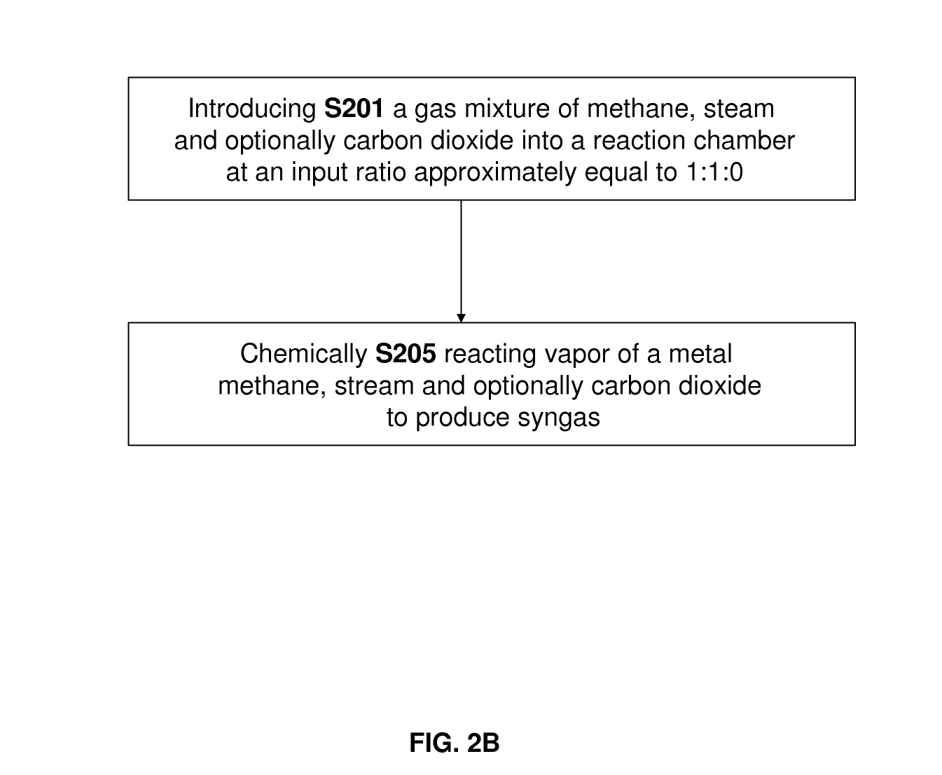

The syngas-producing chemical reaction involving the metal vapor may be carried out at any stoichiometry, including but not limited to a methane/water/carbon dioxide input ratio of 1:2:1 and a methane/water/carbon dioxide input ratio of 3:2:1 (see FIG. 2A) and a methane/water/carbon dioxide of 1:1:0 (see FIG. 2B) and/or any other methane/water/carbon dioxide input ratio.

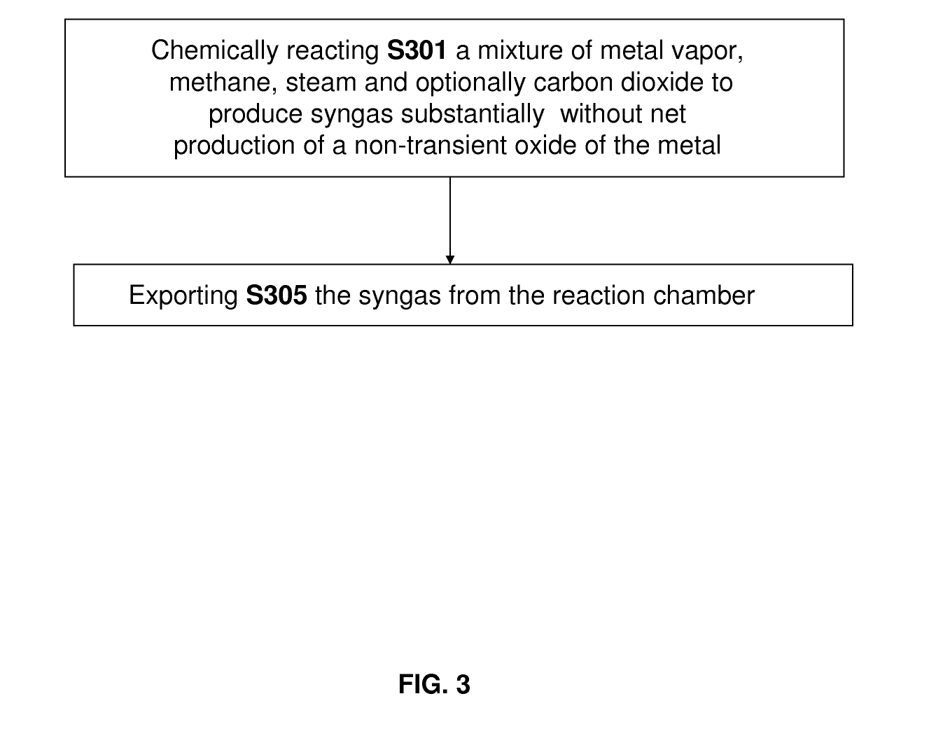

In some embodiments, the amount of oxidized metal in the exported gas stream may be significant (for example, the molar ratio of oxidized metal to non-oxidized metal in the gas stream may be at least 0.1 or greater). In other embodiments (see FIG. 3), it is possible to carry out the chemical reaction so that syngas is produced substantially without any net production of an oxide of the metal. In this case, oxidized metal may be present within the reaction chamber and/or in the exported gas stream only in trace amounts.

Although not a limitation, investigations carried out by the present inventor have indicated that when a methane/water/carbon dioxide input ratio is 3:2:1 or 1:1:0 (or other possible ratios), only transient metal-oxide molecules are produced in the chain of sub-reactions making up the overall chemical reaction. In this case, the syngas-producing chemical reaction may occur such that substantially no net stable amounts of product metal-oxide are produced by the chemical reaction.

The present inventor has recognized that previous syngas techniques (for example, see any of the Yogev documents) involving metal liquid or vapor which may appear as net CO₂-consuming processes may, in fact, release more CO₂ than is consumed. For example, even if a portion of an overall cycle whereby metal is oxidized in a syngas-producing reaction and then is regenerated back to non-oxidized metal is CO₂-consuming, this does not mean that the cycle as a whole is a net CO₂-consuming process. On the contrary, investigations conducted by the present inventor (see the discussion below) indicate that the amount of CO₂ released by the metal-regeneration phase of the cycle exceeds the amount of CO₂ consumed in the syngas-producing chemical reaction where the metal is oxidized.

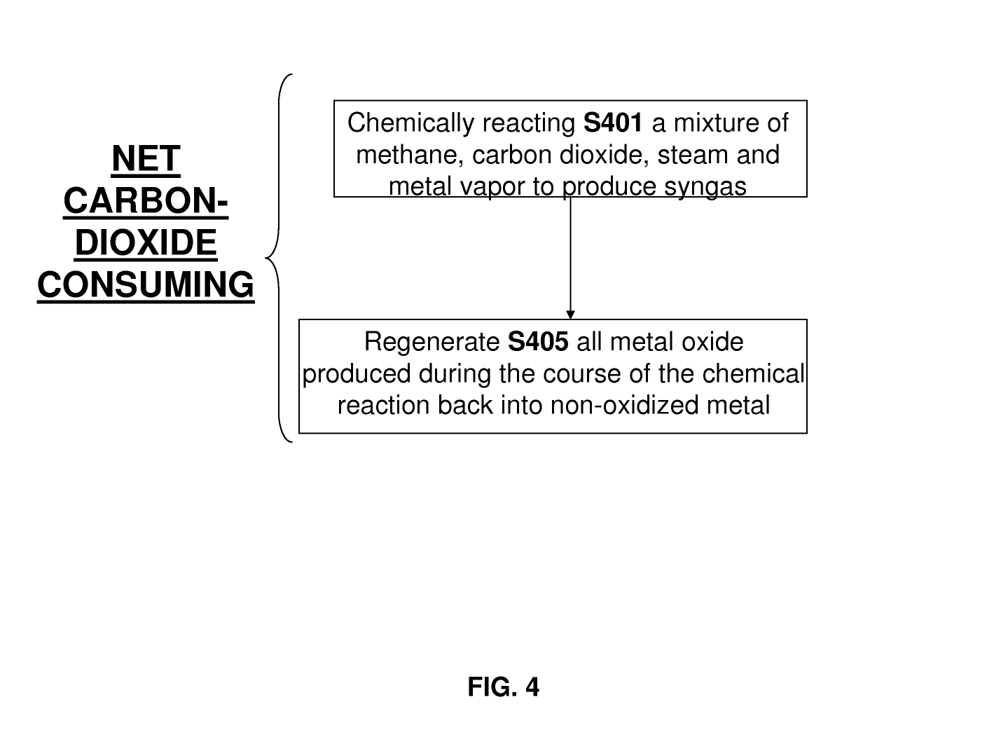

Some presently-disclosed embodiments (see FIG. 4) relate to an apparatus and method and product where (i) substantially all metal oxide that is produced during the chemical reaction is regenerated back into non-oxidized metal; and (ii) the combination of the syngas-production and the conversion of metal oxide back into non-oxidized metal is net CO₂-consuming.

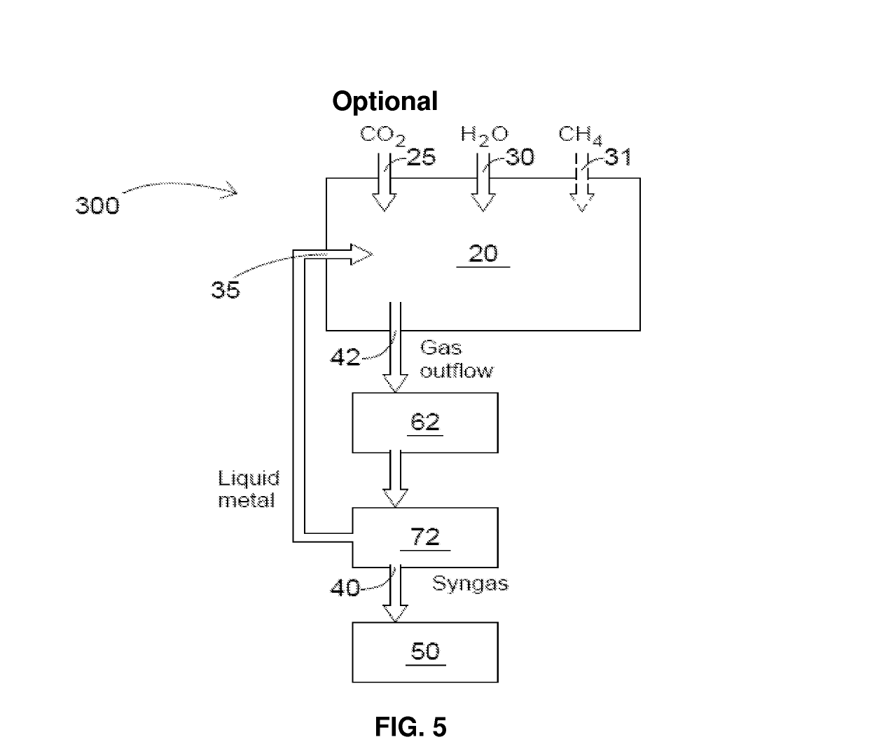

Reference is made to FIG. 1, which is a flow chart of a syngas production process, and to FIG. 5 which is a block diagram of a system 300 in which the routine of FIG. 1 may be carried out according to some embodiments.

In step S101, a gaseous mixture of metal vapor, methane, water and optionally carbon dioxide undergoes a chemical reaction within reaction chamber 20. In the non-limiting example of FIG. 5, three separate input streams for non-metal gases are illustrated—an optional carbon dioxide input 25, a steam input stream 30 and a methane input stream 31. The skilled artisan will appreciate that this is not a limitation and that there are other possibilities. For example, the non-metallic gases may be pre-mixed and enter the reaction chamber 20 as a single stream.

Metal vapor (for example, Zinc vapor and/or Magnesium vapor and/or Cadmium vapor and/or Strontium vapor) present within reaction chamber 20 may participate in the chemical reaction of step S101 of FIG. 1. In one non-limiting example, liquid-phase metal is introduced (for example, sprayed or sprinkled) into reaction chamber 20, and at least part of this liquid-phase metal may be vaporized to generate substantial metal vapor pressure (e.g., close to but possibly below the metal boiling temperature), at the ambient temperature/pressure conditions within reaction chamber 20.

A gas outflow 42 including product syngas, metal vapor and/or suspended liquid droplets (i.e. mist) of metal and/or small particles of metal oxide may be exported, in step S105 of FIG. 1, from reaction chamber 20. In one non-limiting example, gas of this outflow is cooled (see step S109 of FIG. 1) in condenser 62—for example, by at least 50 degrees C. or at least 100 degrees C. or at least 150 degrees C. or at least 200 degrees C.).

Optionally, the gas sent to condenser 62 includes solid particles of oxidized metal, for example, suspended in the gas (i.e. either directly in the gas for example as an aerosol or attached to or associated with gas-suspended droplets). The solid metal-oxide particles may be of any size and may have any size distribution. In some embodiments, the sold metal-oxide particles may include very small particles of a few molecules or even a single molecule, or may include colloid particles or sub-micron particles or particles having a size that exceeds a micron. For example, a majority of the particles may have a size less than 100 microns or less than 10 microns or less than 1 micron.

The cooling of step S109 may be effective to induce condensation of metal vapor into liquid-phase metal. For example, the liquid phase metal may include mist of metal. In one particular example, a majority or significant majority of liquid-phase metal is present, after the cooling of step S109, as a mist (i.e. suspension of liquid droplets).

In step S113, the liquid-phase metal (i.e. non-oxidized liquid-phase metal) may be separated from the syngas—for example, in demister 72. Optionally, solid particles of oxidized metal are also separated.

As illustrated in FIG. 5, the separated liquid-phase metal may be returned to reaction chamber 20 via one or more inlets 36. For example, the returning of liquid may be ‘gravity-driven’ by flowing liquid from a higher elevation to a lower elevation, or may be driven by a pump, or carried out in any other manner.

In some embodiments, the input of metal 35 into reaction chamber 20 may be such that a majority or a significant majority or substantially all metal that re-enters into reaction chamber 20 via input 35 is non-oxidized metal rather than oxidized metal.

In some embodiments, at least one point in the ‘journey’ whereby the liquid metal that is sent from demister 72 back to reaction chamber 20 via input 35, the liquid mixture is a novel composition of matter/mixture.

This novel mixture comprises a mixture of liquid metal, gas bubbles including syngas and optionally carbon dioxide, and small particles (i.e. either suspended in the mixture or ‘at the bottom’ of the mixture) of oxidized metal. The gas bubbles suspended in the liquid metal of this mixture may also include methane gas and/or carbon monoxide and/or steam and/or carbon dioxide. In one example, a molar ratio within the gas bubbles between carbon monoxide and hydrogen gas is approximately (i.e. within a 30% or 20% or 10% or 5% or 1% tolerance) 1:2. In one example, a molar ratio within the gas bubbles between carbon monoxide and hydrogen gas is approximately (i.e. within a 30% or 20% or 10% or 5% or 1% tolerance) 1:3.

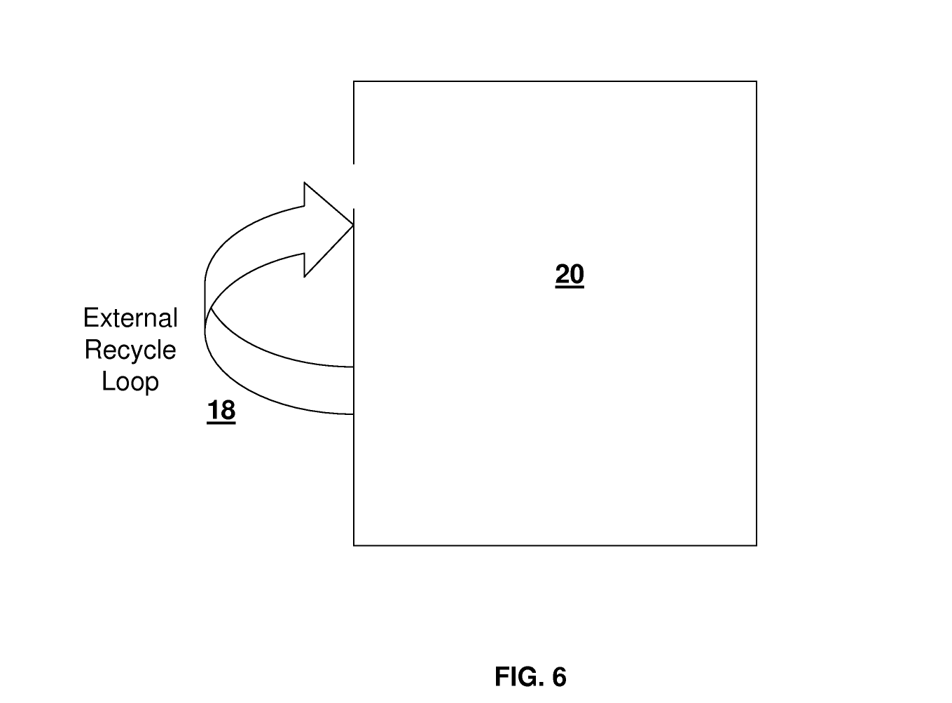

In some embodiments, as illustrated in FIG. 6, one or more ‘recycle loops’ 18 (for example, including pipes or other conduits, chambers, reactors, etc) are provided whereby material of the metal (i.e. often mixed with other non-metal material for at least a portion of the recycle loop) leaves the chemical reaction chamber via one opening/outlet and later re-enters (i.e. in the same form or in a different from) the reaction chamber (i.e. either a ‘single reaction chamber’ or a ‘virtual chamber’ as discussed below). Although some embodiments certainly refer to the case where this a ‘fluid path’ throughout the recycle loop, this is not a limitation, and material may be automatically conveyed in through the recycle loop any manner—for example, via a fluid a fluid path or a bye mechanical device (e.g. a robotic device, or conveyer belt or any other device) that may transport a solid or liquid or any other form of the liquid.

One example of a recycle loop is described in a FIG. 1A of PCT/IL2007/001576 where metal oxide leaves reactor the reactor (see 145 of PCT/IL2007/001576) via some sort of conduit in any other manner to metal regeneration unit 160. After regeneration in metal unit 160, the material in PCT/IL2007/001576 returns to reaction chamber 120 (see 135 of PCT/IL2007/001576).

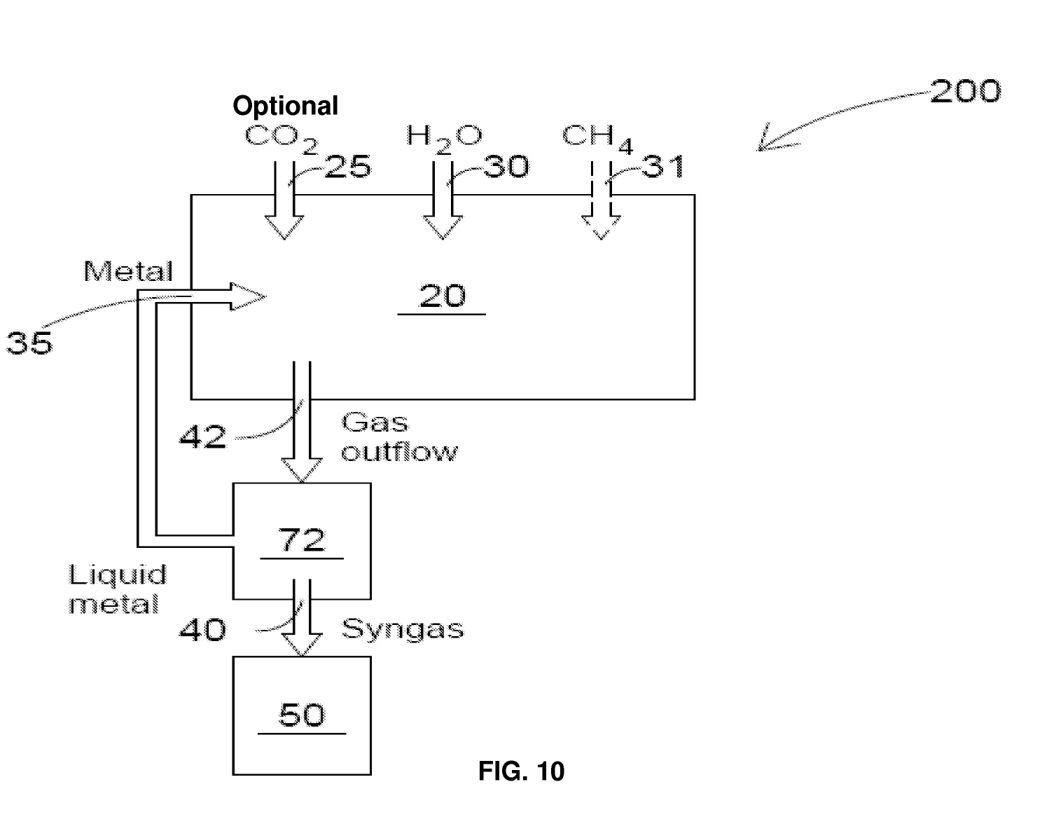

A ‘recycle loop’ is illustrated schematically as element 18 in FIG. 6. It is appreciated that there may be a plurality of different (i.e. overlapping or non-overlapping) recycle loops associated with a single physical reaction chamber or to a plurality of reaction chambers (i.e. ‘virtual’ reaction chamber). For example, as discussed below with reference to FIG. 10, some embodiments relate to the case whereby the set of all ‘recycle loops’ (shown schematically as 18 in FIG. 6) includes a loop where metal (i.e. either non-complexed and/or non-complexed or atomic metal and/or complexed metal such as oxidized metal) leaves via the reaction chamber as a gas and/or suspended in a gas flow (i.e. either in liquid phase or a small solid particle) and later returns (i.e. in any manner—for example, in substantially ‘purely-non-oxidized form’ where a majority or significant majority or substantially all metal returning in 35 is non-oxidized) in liquid form.

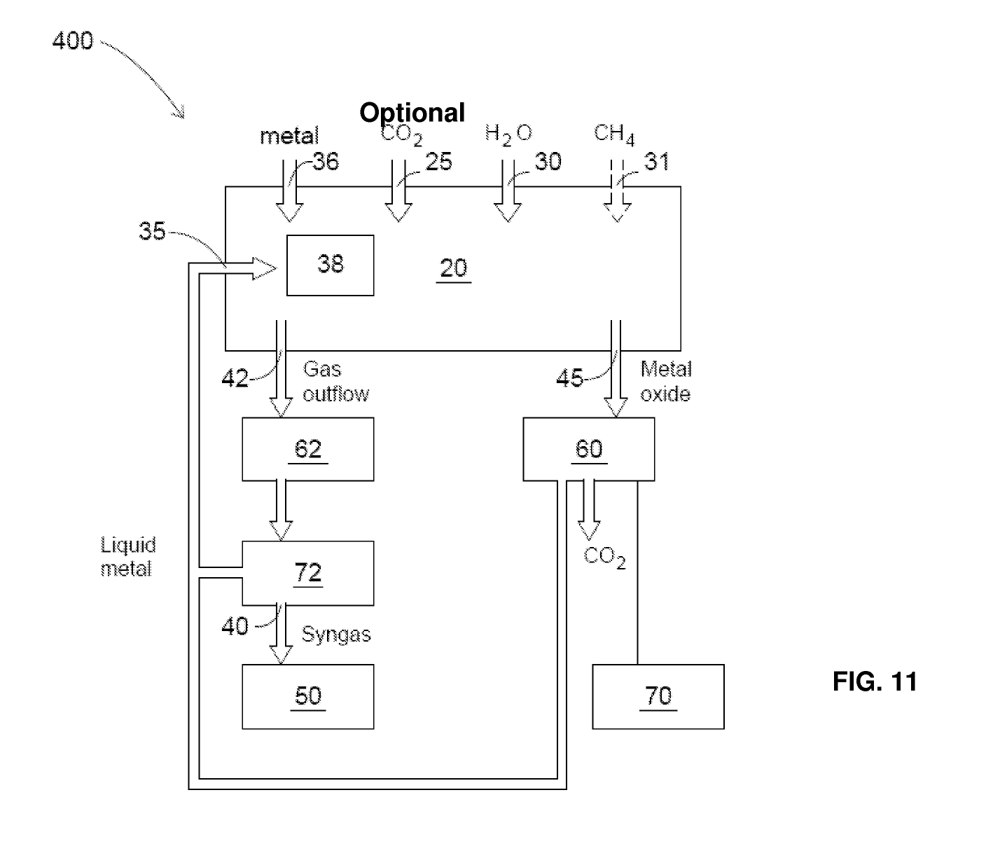

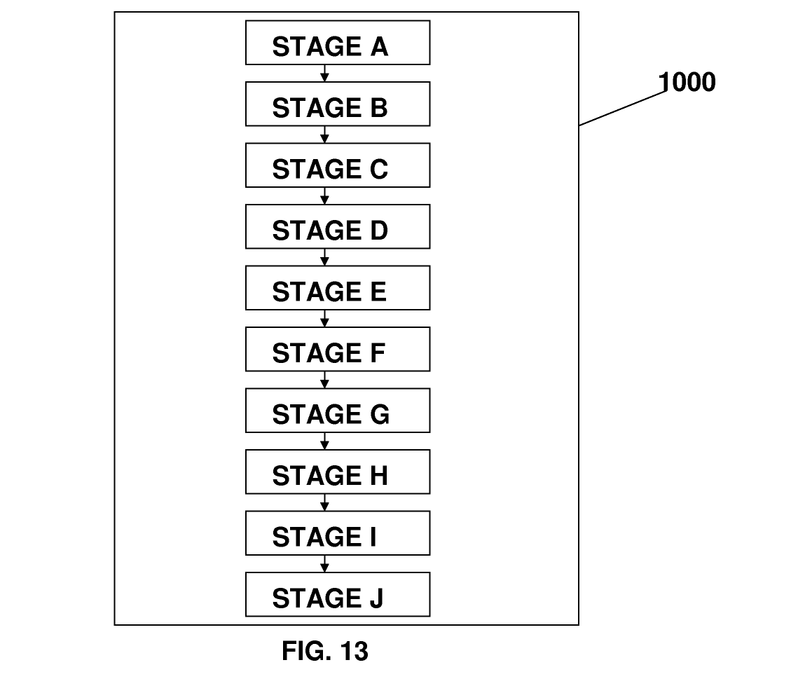

In FIG. 11, there are a plurality of recycle loops—a first loop on the left similar to that illustrated in FIG. 10, and a second recycle loop on the right where metal atoms (i.e. for example, mostly in oxidized form) leaves (see 45) in solid or liquid form and not suspended in a gas. Similarly, the system of FIG. 13 includes a first recycle loop whereby the metal substance in any chemical form (i.e. either complexed such as oxidized or non-complexed such as non-oxidized) leaves the reaction chamber 20 as part of a gas flow as a gas or suspended in a gas (see 42 of FIG. 13) and a second first recycle loop whereby the metal substance in any chemical form leaves the reaction chamber 20 not as part of a gas flow (see 45).

Some embodiments of the present invention relate to methods and apparatus where the schematic set of ‘all recycle loops’ (see 18 of FIG. 6) associated with a single or virtual reaction chamber is such that a majority of the metal substance (i.e. in any chemical form) or a significant majority or substantially all of the metal substance that passes through any of the recycle loops leaves reaction chamber 20 specifically as part of a gas flow—i.e. in a gas/vapor phase and/or suspended in gas as a droplets (i.e. mist) or as solid particles (i.e. particle suspended directly in the gas and/or attached to or associated with gas-suspended droplets).

As discussed below, sometimes metal substance (i.e. the ‘atoms of the metal’ which leave can be in any physical or chemical form such as oxygenated metal and non-oxygenated metal) may leave reaction chamber 20 in oxidized form (see 45 of FIG. 11 where at least some of the material leaving reaction chamber 20 is a metal oxide; in another example, gas-suspended metal oxide particles are carried out of reaction chamber 20 by a gas flow). Sometimes the metal substance may leave reaction chamber in non-oxidized form—for example, as a metal vapor or as a metal mist or as part of liquid stream (see 42 of FIG. 11) or as part of a gas stream (see 45 of FIG. 11) in any other manner.

Some embodiments of the present invention relate to methods and apparatus where the schematic set of ‘all recycle loops’ (see 18 of FIG. 6) is such that a majority of the metal substance (i.e. a majority of the ‘metal atoms’ in any chemical form) or a significant majority or substantially all of the metal substance (i.e. the metal ‘atoms’ in any chemical form) that passes through any of the recycle loops leaves reaction chamber 20 specifically in non-oxidized form.

In some embodiments, any feature or combination of features disclosed in the Yogev documents WO/2008/050350 and WO/2009/010959 may be provided—for example, provide in combination with any teaching or feature disclosed herein in any combination.

All references cited herein are incorporated by reference in their entirety. Citation of a reference does not constitute an admission that the reference is prior art.

### DEFINITIONS

For convenience, in the context of the description herein, various terms are presented here. To the extent that definitions are provided, explicitly or implicitly, here or elsewhere in this application, such definitions are understood to be consistent with the usage of the defined terms by those of skill in the pertinent art(s). Furthermore, such definitions are to be construed in the broadest possible sense consistent with such usage.

As used herein the specification and in the claims section that follows, the term synthesis gas, also called syngas and the like refer to “a mixture of CO, CO₂ and H₂ gases.” In contrast to carbon monoxide and hydrogen, the presence of carbon dioxide is not strictly required. In many commercial implementations, CO₂ may not be present, or may only be present in only trace amounts. In one non-limiting embodiment, a ratio between the partial pressures of carbon monoxide and hydrogen is less than one—for example, about 1:2. In one non-limiting embodiment, a ratio between the partial pressures of carbon monoxide and hydrogen is equal to at least 0.03 or at least 0.05 or at least 0.1 or at least 0.15 or at least 0.2 and/or at most 5 and/or at most 3 or at most 1.

When a chemical reaction to generate syngas is performed, this refers to a useful industrial reaction, rather than some process that would only generate small quantities of syngas. Thus, when CH₄ is chemically reacted with other substances into syngas, at least 50% of the CH₄ may be chemically reacted in the syngas chemical reaction to form syngas (i.e. so that the carbon of the methane is incorporated into carbon monoxide of the syngas and the hydrogen of the methane is incorporated into the hydrogen of the syngas). The syngas may be exported syngas from the reaction chamber.

Some embodiments refer to an ‘input ratio’ within a given ‘deviation’ or ‘tolerance.’ In this context, the terms ‘deviation’ and ‘tolerance’ are synonymous. A input ratio of X:Y:Z for molecules m1, m2, m3 within a tolerance a tolerance of p % means that: (i) an input/stoichiometric ratio for molecules m1 and m2 exceeds X/Y*(1−p/100) is and less than X/Y*(1+p/100); (ii) an input/stoichiometric ratio for molecules m1 and m3 is greater than X/Z*(1−/100) and less than X/Z*(1+p/100); (iii) an input/stoichiometric ratio for molecules m2 and m3 is greater than Y/Z*(1−p/100) and less than Y/Z*(1+p/100);

Some embodiments of refer to “atoms of the metal” carrying out some sort of action—for example, moving from one location to another (e.g. leaving or entering a reaction chamber). The phrase “atoms of the metal” refer to any form of the metal—i.e. in an atomic form or complexed as part of any molecule (for example, oxygenated). The term “atoms of the metal” is broader than and is not to be confused with “atomic metal” or “atomic form metal.” Thus the phrase ‘atoms of the metal’ is only provided in order to keep track of/account for the locations of the metal substance in any form whatsoever and is not intended to relate to the particular form (i.e. atomic vs. molecular, non-oxygenated vs. oxygenated, etc).

Embodiments of the present invention refer to chemical reactions ‘involving’ both a metal vapor and/or mist of a metal and one or more non-metallic gases. In this case, the metal vapor may function as a ‘reactant’ rather than a catalyst—for example, as discussed in WO/2008/050350 of Yogev (Yogev-1) or in WO/2009/010959 of Yogev (Yogev-2). However, it might be said that the metal vapor provides catalytic functionality in accelerating the overall conversion of input natural gas to product syngas.

For the present disclosure, a ‘majority’ refers to at least 50%. A ‘significant majority’ may refer to at least 50%, or at least 60%, or at least 70%, or at least 80%, at least 90%, or at least 95%, or at least 99%, or at least 99.5% or at least 99.9%.

The term “metal vapor” refers both to gas-phase metal in single-phase situations where liquid metal is not present as well as multi-phase situations where metal vapor is the metal gas that co-exists with liquid metal.

Some embodiments of the present invention relate to methods and apparatus for effecting a syngas-producing chemical reaction where there is ‘substantially net production of an oxide of the metal by a syngas-producing chemical reaction.’ The skilled artisan will appreciate that some quantity, even a significant quantity, of ‘transient metal-oxide molecules’ may be produced in the reaction chain (for one non-limiting example, see reaction equations (19)-(23) below). These transient metal-oxide molecules are not considered part of a ‘net production’ of an oxide of the metal.

Furthermore, the skilled artisan will appreciate that in situations where there is a chemical interaction involving a metal, methane, water and optionally carbon dioxide (for example, where intermediate transient products in the reaction chain yield transient oxidized metal) that even chemical reactions where ‘substantially net production of an oxide of the metal by a syngas-producing chemical reaction’ may in fact produce trace net quantities of the oxide of the metal (i.e. a ‘stable’ metal oxide as opposed to a transient metal oxide which may be produced even in significant quantities).

The skilled artisan will appreciate that in an endothermic chemical chain reaction from input ingredients to output products, it may be possible for the reaction to occur in reaction conditions (for example, pressure or temperature) where the thermodynamic equilibrium conditions alone would predict a situation where the quantity of some transient intermediate molecule is exactly zero. Nevertheless, the skilled artisan will appreciate that there are yet causes to obtain some non-zero “trace quantities” of that intermediate molecule quantity. These trace transient molecule quantities are distinguished by at least one or more of several features:
(a) A quantity of the transient molecule “trace quantity” (i.e. oxide of a metal) produced is a small fraction of the product molecules (for example, carbon monoxide), a fraction at least less than 10%, or less than 1%, and less than 0.1%.
(b) The transient molecule “trace quantity” does not accumulate in linear proportion to input quantities of reactant ingredients, while in contrast normal “products” of the reaction (i.e. as opposed to trace quantities of by-products that are an intermediate molecule of the chemical reaction) typically accumulate in linear proportion to the input quantities of ingredients.

The qualification of “substantially not produced” trace quantities refers to any selected from the above list of distinctive features.

As known to persons skilled in the art, such trace quantities can be obtained for several reasons;
(a) Fluctuations about thermodynamic equilibrium. As known in the art, chemical reactions are dynamic processes which at any finite time frame have fluctuations about an average ideal thermodynamic equilibrium state. Statements are made commonly about the ideal equilibrium state of the reaction with an understanding of the existence of such fluctuations which create “trace amounts” of deviation from the exact thermodynamic equilibrium state.
(b) Incomplete finite time reaction. Even if the thermodynamic equilibrium state at the given reaction temperature is such that all input ingredients are supposed to be converted to products, with no intermediate molecules left either. Any real manufacturing process is conducted over finite time (average duration of atom in the reaction chamber), and thus with incomplete efficiency. Hence there will always be some trace quantities of molecules in the transient intermediate process state.
(c) Error deviations. Exact zero quantity product of a reaction at some exact ratio of input ingredients will deviate from zero for any deviation from the exact ratio of input ingredients. Thereby producing some small quantities that do cumulate in proportion to the input flow of ingredients. i.e., in any realized manufacturing process there will be quantities produce in proportion to the error deviation from the exact formula requirements. Such by product small quantities proportional to the error deviation are also meant to be included under the description of “substantially not produced” trace quantities.

Thus, the skilled artisan will appreciate that the phrase ‘substantially’ without net production of a non-transient oxide is a relative phrase describing relative production by the chemical reaction of the syngas product (or a component thereof) relative to the ‘trace quantity’ of the oxidized metal by-product.

In some non-limiting examples where there is substantially ‘no net production’ of a non-transient oxide of a metal, a ratio between a number of moles of metal oxide produced by the chemical reaction to a number of moles of CO of the syngas produced by the chemical reaction is at most 1:10 or at most 1:20, or at most 1:50 or at most 1:100 or at most 1:1000.

The skilled artisan will know how to detect and/or quantify the ‘trace amounts’ the metal oxide—for example, using a mass spectrometer or any other device.

Some embodiments of the present invention relate to a ‘mist’ which is defined as gas-suspended droplets.

Some embodiments of the present invention relate to ‘regenerating’ of a metal oxide back into a metal. A first example of ‘metal’ regenerating is ‘external metal regenerating’ whereby metal oxide that leaves the reaction chamber in any manner (for example, as a pile of particles or within a flowing stream of liquid or as solid particles suspended in a gas flow or in any other manner) is re-generated back into metal outside of the reaction chamber and/or not in the ‘context’ of the syngas-producing chemical reaction (i.e. ‘external’ to the reaction). For example, it may be possible to subject metal oxide to an electrolysis process or simply to burn the metal oxide using coal or to effect the external metal regenerating in any other manner.

A second example of ‘regenerating’ of a metal is ‘internal metal regeneration’ where the metal oxide is converted back into metal within the chemical reaction chamber and/or metal oxide is converted back into metal in the context of the syngas-producing chemical reaction. For one non-limiting example, see reaction equations (22)-(23) bellows.

Some embodiments of the present invention relate to a situations where a chemical reaction is carried out in a ‘reaction chamber.’ Although this may relate to a single reaction chamber, the skilled artisan will certainly appreciate that the reaction may be simultaneously carried out in parallel in multiple reaction chambers (i.e. a ‘virtual reaction chamber’). The term ‘a reaction chamber’ relates to both situations—i.e. a single reaction chamber or the case of multiple reaction chambers (i.e. which is a ‘virtual reaction chamber’). Similarly, the case where a substance (e.g. metal or a complex thereof such as oxidized metal or ‘atoms of the metal’) leaves/exits/is exported from ‘a reaction chamber’ or ‘the reaction chamber’ only to be later returned to a reaction chamber’ or ‘the reaction chamber’ refers to either (i) a single reaction chamber situation where the substance leaves and returns to the same reaction chamber; or (ii) a multiple reaction chamber situation where even if the substance leaves and returns to the same virtual reaction chamber, the substance may leave a first one of the reaction chambers (i.e. operating in parallel) and return to a different one of the reaction chambers.

A ‘syngas producing unit’ includes the reaction chamber and other necessary mechanical or electrical or electronic equipment (i.e. valves and/or pressure-regulators and/or temperature-regulators and/or control apparatus and/or analog and/or digitial control electronics and/or control software executed by a digital computer and/or any other equipment that the skilled artisan will recognize after reading the present disclosure as necessary for performing the chemical reaction). Any such structure or combination of structures in conjunction with the reaction chamber may be employed to obtain the ‘syngas producing unit.’

A ‘recycle loop’ refers to a structure where there is a flow path (i.e. via any pipe or conduit or liquid or gas or storage chamber) via which liquid and/or gaseous and/or solid material may leave the reaction chamber (i.e. a virtual reaction chamber) via one opening or outlet and return into the reaction chamber via another opening (or inlet).

A liquefaction unit may refer to a condenser or any other structure known in the art where the temperature/pressure conditions may change (for example, by lowering temperature) such that within the unit a vapour/gaseous substance (for example, metal vapour) is converted into a liquid-phase substance (i.e. either a mist of gas-suspended droplets). In some embodiments, the liquefaction unit or condenser may be configured so that for a given substance (e.g. a metal) a majority of the gas-phase substance entering the liquefaction unit or condenser may be converted to liquid-phase.

A Brief Non-Limiting Discussion Related to Demister 72

Various features will now be discussed according to example embodiments, including features relating to (A) separation and recycling of reactant metal from syngas outflow, possible ratios of gas ingredients, and example methods for syngas formation with a metal reactant vapor.

As noted above in the discussion of step S113 of FIG. 1, in some embodiments, in some embodiments, a demister (see 72 of FIG. 5) may be employed to separate liquid-phase metal from a gas mixture including syngas. This liquid-phase metal may be returned to reaction chamber 20.

Although certainly no a limitation, in some embodiments, droplets separation can be done by demister (72) and/or by droplet filters/coalescers apparatus, (for example as discussed in PCT patent application No.: PCT/NL2006/000283, of Larnholm Per-Reidar; and Schook Robert; (NL). publication No. WO/2006/132527, which are incorporated by reference for all purposes as if fully set forth herein.

In some embodiments the condenser 62 and/or the condensation of step S109 of FIG. 1 is carried out such that the exhaust products temperature is lowered to at least 300° C. below the boiling temperature of the metal at the operational pressure of the condensation chamber.

Known art of demisters are commonly centrifugal flow units designed to coalesce mist droplets and/or solid particles from their gas flow. They resemble cyclones and hydro-cyclones and are usually used as a secondary stage in conjunction with classical wet scrubbing units. Also, electrostatic precipitators (ESPs) are widely used to remove fine solids and liquid droplets from gas streams. The present art technology of droplet separation from gas is further elaborated in PCT patent application No.: PCT/NL2006/000283.

In some embodiments, there may be an advantage in recovering heat from the condensing process and for transferring said heat to heating other steps of the process (e.g., for heating the feedstock).

Example Ratios of Gas Ingredients

Often, in the context of methanol production, the ratio of syngas elements (H₂:CO) is about (2:1). This is because the chemical reaction to produce methanol is

CO+2H₂→CH₃OH (12)

Therefore, in some embodiments, the ingredients feedstock mix (CH₄:H₂O:CO₂) may be chosen so that the proper out flow of about (H₂:CO=2:1) is obtained. However, the skilled artisan will appreciate that this syngas ratio is not a limitation—instead, it may merely be commercially advantageous in certain scenarios.

Below, by way of example, three specific ingredients feedstock mix/gas input ratios are discussed: (i) a first ratio where the input ingredients ratios is (CH₄:H₂O:CO₂) is exactly or about (1:2:1) (CASE I); (ii) a second ratio where the input ingredients ratios is (CH₄:H₂O:CO₂) is exactly or about (3:2:1) (CASE II); and (iii) a third ratio where the input ingredients ratios is (CH₄:H₂O:CO₂) is exactly or about (1:1:0).

Not wishing to be bound by any theory, it is currently believed that CASE I and CASE II may be particularly relevant for methanol production, while CASE III may be particularly relevant for steam reforming.

Furthermore, it is recognized that there may be other uses for syngas, and other motivations to producing syngas. Thus, it is appreciated that the presently-disclosed teachings are by no means limited to methanol production and/or to steam reforming.

As discussed above, in some embodiments, stoichiometry and/or input and/or feedstock ratios that are only approximate these ratios (or any other ratio) may be employed—for example, within a 12% tolerance or a 10% tolerance or a 5% tolerance or a 1% tolerance or any other tolerance disclosed herein.

Case-I—Stoichiometric for (CH₄:H₂O:CO₂) Substantially Equal to (1:2:1).

As was disclosed in PCT/IL2007/001576, and PCT/IL2008/000964 of Yogev, an input ingredients ratios for (CH₄:H₂O:CO₂) may be (1:2:1). This is the embodiment presented in the PCT patent applications numbers. The associated reaction in the presence of Zn metal reactant is:

(14)

CH₄+2H₂O+CO₂+2Zn→2CO+4H₂+2ZnO (Case-I)

The process disclosed in the Yogev documents may appear to be a net-CO₂ consuming process. However, the present inventor believes that the entire cycle, including the reaction where oxidized metal is externally regenerated back into non-oxidized metal in the metal regeneration unit is, in fact, a net CO₂ producing process.

The proof is provided in the present section. First, regeneration of Zinc is done by reaction with coal

2ZnO+2C→2Zn+2CO (15)

Then the excess CO is burnt in air in the reaction

2CO+O₂→2CO₂ (16)

Comparing with the first input of feedstock gases, it is evident that for each one CO₂ molecule consumed at the start two molecules (2CO₂) are eventually emitted back to the air. i.e., a “deficit” of one net CO₂ molecule emitted to the environment (rather than consumed) for each CH₄ molecule that is consumed in a sustained process of syngas production.

Despite the fact that certain stoichiometries may possibly be net-CO₂ producing stoichiometries, there is certainly no explicit or implied limitation that precludes operating at such stoichiometry.

Furthermore, as noted above, it is certainly possible to combine certain presently disclosed teachings with any feature previously disclosed in Yogev or in any other disclosure.

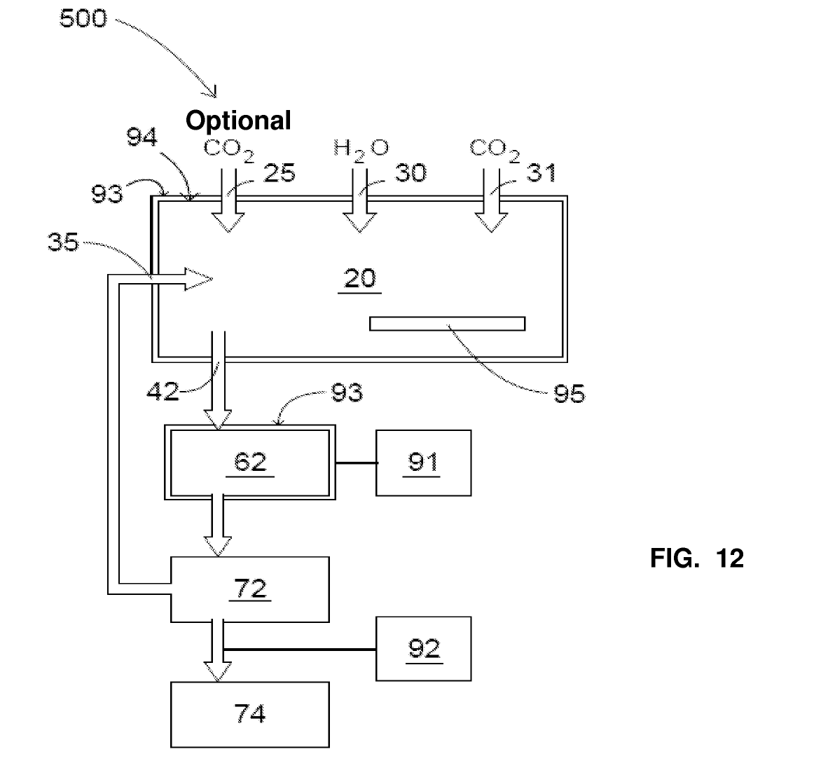

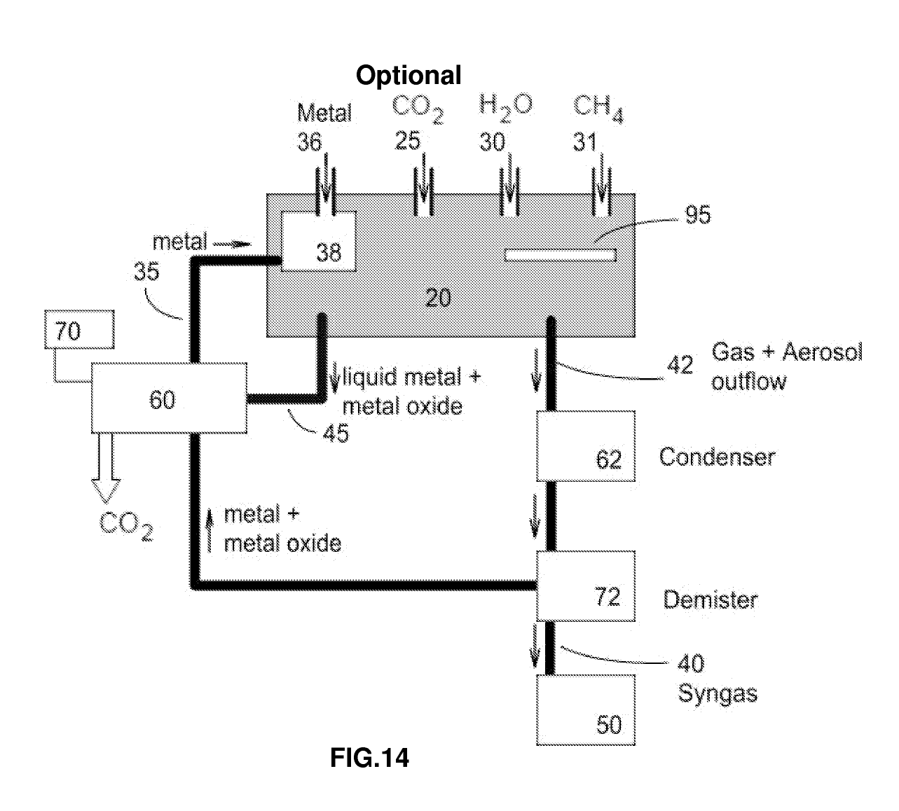

In some embodiments related to certain figures (for example, FIG. 1 or FIG. 14), metal oxide recycling from both the aerosol products and liquid deposits may be needed, as illustrated in the system of FIG. 12. The metal oxide recycling can be done as previously described in the Yogev Method patent applications.

Case-II—Stoichiometry for (CH₄:H₂O:CO₂) Substantially Equal to (3:2:1).

In yet another example, it is possible to reactant vapor metal with non-metallic gases provided at an input feedstock ratio of (CH₄:H₂O:CO₂)=(3:2:1).

For this specific case, the associated reaction in the presence of Zn metal reactant may be written as

(17)

3CH₄+2H₂O+CO₂+3Zn→4CO+8H₂+3Zn (Case-II)

Investigations carried out by the present inventor, and discussed below, indicate that “Case II,” may be useful for carrying out a syngas-producing chemical reaction involving metal vapor where no substantially net metal oxide is produced (e.g., ZnO) in the reaction products.

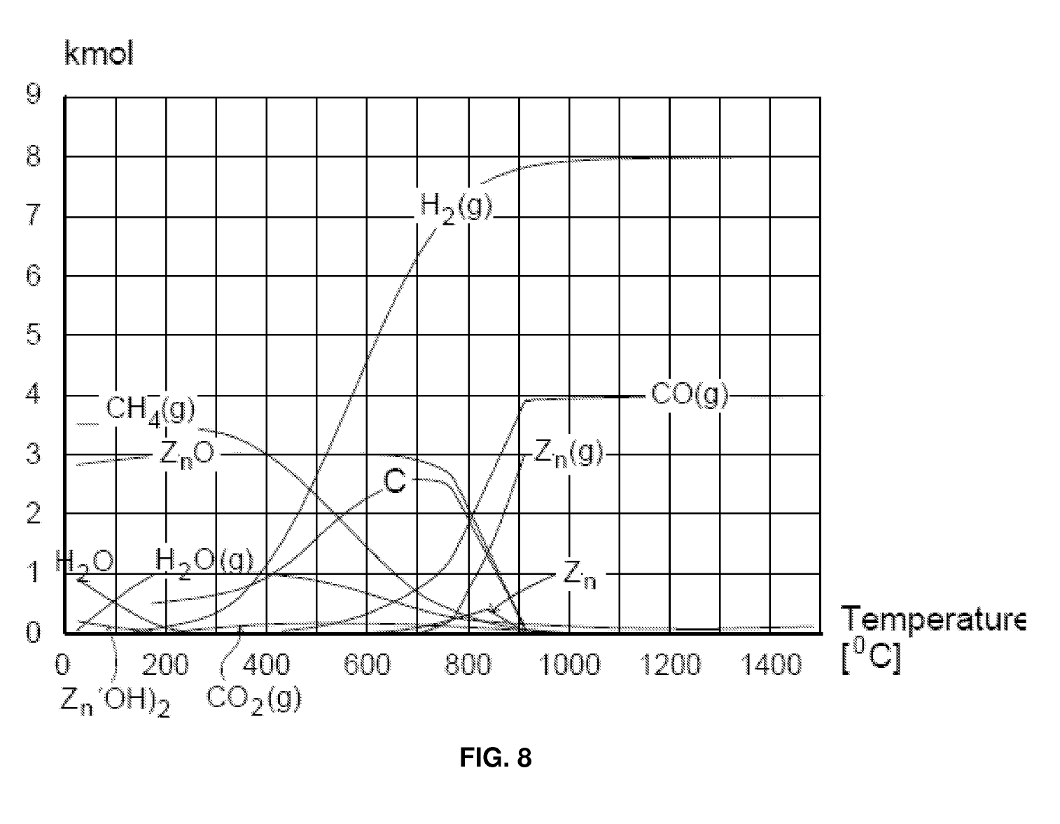

The skilled artisan will appreciate that even though a given ‘theoretical result’ may describe a process whereby absolutely no net metal oxide formed, in reality the situation may be different. For example, at a given temperature there will be an equilibrium concentration (i.e. related to the ‘trace quantity’ or ‘trace amount’ of net oxidized metal produced by the reaction) of metal oxide produced by the chemical reaction (as illustrated in FIG. 8).

It is now disclosed that, in some embodiments, at any given temperature, the Case-II proportion 3:2:1 of ingredients (or an approximation thereof) is useful for providing the minimum concentration of metal oxide in the reactant output. In fact, the relative quantities of metal oxide produced (i.e. relative to the 1:2; 1 case disclosed in Yogev) may be substantially lower—for example, trace quantities of metal oxide vs. significant quantities.

Potentially, there is substantially no need for any external recycling/external regeneration of metal from metal oxide (as illustrated in the systems of FIGS. 5 and 10 which lack a recycle loop that is ‘fed’ by liquid outflow from the reaction chamber 20).

The skilled artisan will appreciate that because an ‘absolute no metal oxide’ situation may be practically impossible, in some systems, there may be a very slow accumulation of metal oxide liquid or solid deposition at the bottom of the reaction chamber 200. Alternatively or additionally, there may be formation of small particles of gas-suspended metal oxide (i.e. either directly suspended in the gas stream or attached to gas-suspended liquid droplets) which may exit outlet 45 as part of and/or carried by a gas stream (for example, see FIG. 11).

As discussed above, metal oxide particles may be processed in a number of ways. For example, the metal oxide particles may be incorporated into and/or mixed a flow of the liquid metal that is formed by demisting and this is returned to the reaction chamber 20.

One ‘price’ that may be paid by operating at this stoichiometry is that the rate of consumption of expensive natural gas may exceed the natural-gas-consumption rate for the 1:2:1 case.

In the present section, a proof that ZnO (or any other metal oxide) can theoretically be eliminated from the products of the syngas-producing chemical reaction when a feedstock ratio of (3:2:1) is employed. At an arbitrary methane ratio “x”, assuming all methane is consumed, the overall reaction equation is:

xCH₄+2H₂O+CO₂+yZn→(1−x)CO+2(1+x)H₂+(3−x)ZnO+(y−(3−x))Zn (18)

For equation (18), a minimum value of metal oxide may be obtained (and this minimum is zero) when x=3, as defined for the presently-disclosed “Case-II.”

In contrast to the situation of Case I whereby significant quantities (and not only trace quantities) of metal oxide are formed, and where there may be a stronger need for ‘external’ metal reforming, employing the stoichiometries of Case II (and Case III) may obviate or even eliminate the need for ‘external’ metal regenerating.

Instead, the metal oxide may be ‘internally’ regenerated into metal within reaction chamber 20 and/or in the course of the syngas-producing chemical reaction. Consider the following chemical equations for a syngas-producing reaction:

Zn+CO₂→ZnO+CO(exothermic Q=−67 kJ) (19)

Zn+H₂O→ZnO+H₂(exothermic Q=−70 kJ) (20)

2Zn+CO₂→2ZnO+C(exothermic Q=−307 kJ) (21)

ZnO+C→Zn+CO(endothermic Q=+240kJ)Zn regenerate. (22)

CH₄+ZnO→Zn+CO+2H₂(endothermic Q=+314kJ)Zn regenerate. (23)

The metal-oxide may be produced in equations (19)-(21) and regenerated in equations (22)-(23).

Thus, as discussed earlier with reference to step S301 of FIG. 3, it is possible to carry out a syngas-producing chemical reaction involving metal vapor, methane, steam and optionally carbon dioxide such that there is substantially no net production of non-transient oxide of the metal.

In some embodiments, the metal reactant (e.g. Zinc) may operates dynamically in the cycle of reactions comprising of the processes noted above. Thereby, the metal reactant accelerates the generation of syngas products from the feedstock of Methane, Water, and optionally CO₂ substances. The accelerating dynamical role of the metal reactant (i.e. in vapor form) may be useful. In some embodiments of the present method, it may be useful to maintain a temperature of the reaction chamber at a value where the rate of syngas generation is maximal, or within 90% of the maximum.

FIG. 8 illustrates a computer simulation related to Case-II for the non-limiting example where the metal is Zinc. The simulation shows that above the Zn boiling temperature all the Zn equilibrium concentration is in pure Zn state and there is no significant residual Zinc-oxide (ZnO) left. i.e., unlike Case-I, there is no ZnO which needs external regeneration to Zn. [let's discuss] In other words, in some embodiments the Zn may operates in the background which doesn't show at all in the net outflow of products resulting from the feedstock ingredients.

Case-III—Stoichiometry for (CH₄:H₂O:CO₂) Substantially Equal to (1:1:0).

In yet another example, it is possible to reactant vapor metal with non-metallic gases provided at an input feedstock ratio of (CH₄:H₂O:CO₂)=(1:1:0).

In some embodiments, some or all of the benefits described for Case III (i.e. for example, benefits related to substantially no production of metal oxide in the syngas-producing chemical reaction) may also be obtainable at an input feedstock ratio of (CH₄:H₂O:CO₂) substantially equal to (1:1:0).

For example, equation (18) may be modified to remove carbon dioxide from the left side so that the ‘modified equation (18)” is xCH₄+2H₂O+yZ.

In this case, rather than obtaining a ‘no-metal oxide condition at x=3’ (i.e. as in Case II), when there is no CO₂ in the feedstock to the reaction chamber, the corresponding “no metal-oxide output” condition would be satisfied for x=2.

A Discussion of Features Related to Syngas Formation with a Metal Reactant Vapor

Embodiments of the present invention relate to the case where both metal vapor and liquid metal co-reside in the reaction chamber (for example, at least some of the liquid metal may present as gas-suspended liquid droplets). Nevertheless, the gaseous metal vapor may much more relative surface area availability than a liquid droplet.

Thus, in some embodiments, within the reaction chamber, a majority or significant majority or substantially all production of syngas where metal is involved in the syngas-producing chemical reaction occurs when the metal is in the gaseous phase as a vapor.

Some embodiments relate to a process of making syngas from ingredients of gas feedstock comprising natural gas and water (and optionally CO₂,) where there is increased metal reactant surface contact area and minimal susceptibility to degradation due to carbon deposition. In particular, in some operating conditions, a the majority of catalytic reaction of the gas feedstock with the metal is with a gaseous phase of the metal (rather than with a liquid or solid surface metal reactant). Thus, it may be advantageous to carry out the syngas-producing chemical reaction within the reaction chamber 20 at a temperature which is near (within 250 degrees C. or 200 degrees C. or 150° C. or 100° C. or within 50° C. of) or even above the boiling temperature of the metal.

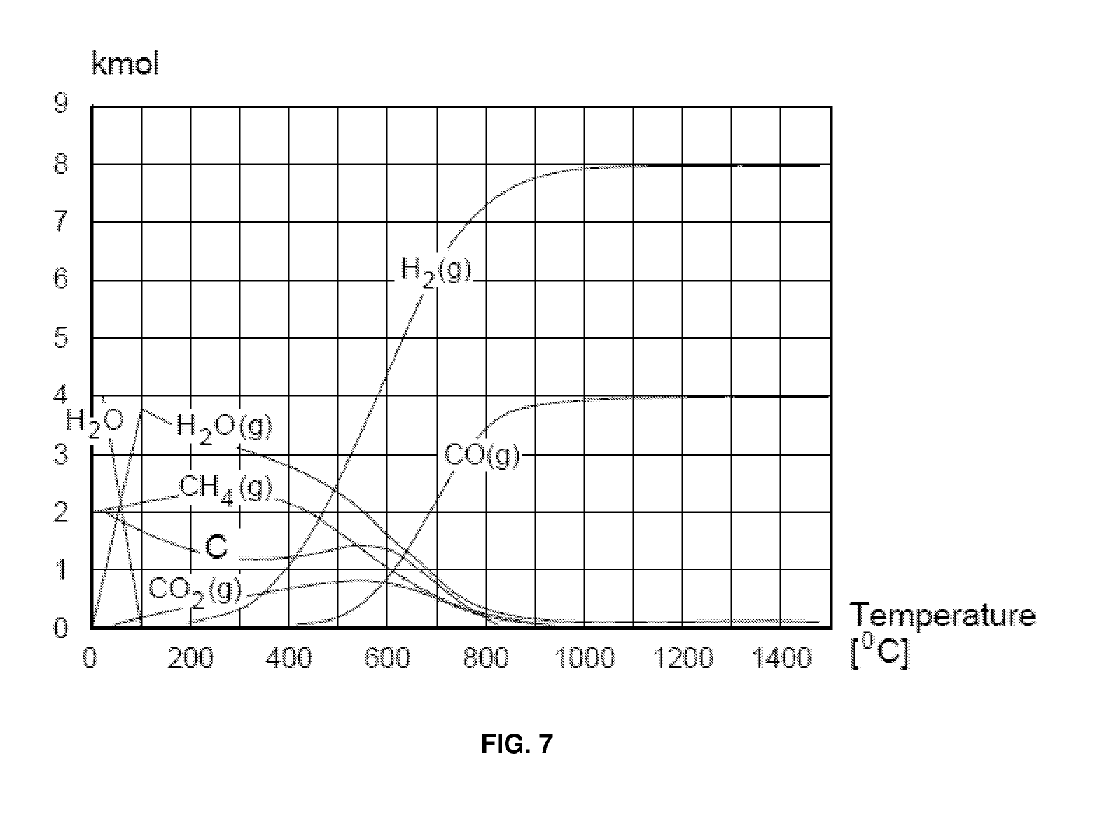

In some embodiments, it may be advantageous to employ metal reactant having a boiling temperature near 1,000° C. (here “near” means within 200° C. or less). For example, as illustrated in FIG. 7, the independent reaction of the gas ingredients may reaches saturation of the desired syngas product. This saturation temperature is the reference temperature with respect to which the choice of all other preferred temperatures is made.

The above noted characteristic saturation temperature may dependent on pressure. The above noted 1,000° C. is for atmospheric pressure. This is not meant to be limiting. Determination of the pressure dependence of the saturation temperature is known in the art. For the sake of clarity, the presentation of the invention is mostly illustrated for the embodiment of reactions at atmospheric pressure. It is clear to those experts of the art that as the saturation temperature is shifted with pressure so accordingly one needs to proportionally shift all relatively determined temperatures of the present method and system. A higher pressure shifts the reforming equilibrium towards the reactants since they compose fewer molecules. For example, for pure steam reforming it is known that, at 30 bar a temperature of 1,400K is needed to reach an equilibrium in which only the products CO and H₂ exist. However, the maximum temperatures used in industry for steam reforming are around 1,200K due to reactor material constraints [1].

Not wishing to be bound by theory, it is noted that the vapor partial pressure is significant (higher than 0.1) for a well defined range of temperatures also below the boiling temperature. It is common practice in the literature to give an approximate formula for the partial pressure “P” as a function of temperature “T” in the neighborhood of the boiling point in the form: Log₁₀(P)=−A/T+B, which we have calculated for Zinc as approximately given by

Log₁₀(P)=(−4023.1)/T+4.4356 (24)

While calculated for environment or air, the above equation for the metal vapor pressure is expected to be a good approximation also for the gas environment of feedstock discussed in the present invention. We conclude that at a temperature of 807° C. (100° C. below the boiling point) the Zinc vapor partial pressure remains higher than 28%, at a temperature of 760° C. (147° C. below the boiling point) the Zinc vapor partial pressure remains higher than 13%, while at a temperature of 707° C. (200° C. below the boiling point) the partial pressure is already lower than 6%. Hence, in at least one embodiment the reaction is operated within a range of less than 200° C. from the metal reactant boiling temperature.

Equation (24) can also be used to deduce the preferred operational temperatures to still have significant vapor pressure if higher pressures are desired for combination with methanol synthesis processes. For example, for operation at pressure of 50 bar the boiling temperature of Zn is 1,470° C. Therefore, at least one embodiment of operation with significant reactant metal vapor pressure according to some embodiments are preferably operated at a temperature within less than 200° C., or within 100° C., or within 50° C. of the respective metal boiling temperature, e.g., from 1,470° C. at pressure of 50 bar.

FIG. 7 illustrates a plot of a numerical simulation of the reaction of some particular syngas mixture (further elaborated on below) of natural gas (CH₄), water (H₂O), and carbon dioxide (CO₂), without any additional metal reactant. We highlight the fact that complete conversion of the ingredients to syngas with the desired ratio (H₂:CO₂) of (2:1) is almost fully obtained by reaching a temperature of about 1,000° C. Hence, there is no particular advantage, and is mostly of added difficulty to operate the reaction with metals which require vaporization at significantly higher temperature. For example, PCT/IL2007/001576, patent application discusses Aluminum (Al), Magnesium (Mg), and Zinc (Zn) on equal footing. Yet, the respective boiling temperatures are given in Table 1 (including those of some other optional catalytic metals)

TABLE 1

| | Standard Enthalpy of | Boiling Temperature at |
|---|---|---|
| Metal | Metal-Oxide [kJ] | atmospheric pressure [° C.] |
| Nickel | −238 | 2,732 (melt: 1,453° C.) |
| Aluminum | | 2,519 |
| Strontium | −592 | 1,382 |
| Magnesium | −601 | 1,091 |
| Zinc | −348 | 907 |
| Cadmium | −258 | 767 |

Thus, according to the present invention, Zinc, Cadmium, and Magnesium are preferred metal reactants. Moreover, in an embodiment with Zinc metal reactant, the reaction should be operated at around 910° C. at atmospheric pressure. In an embodiment with Magnesium metal reactant, the reaction should be operated at around 1,090° C. at atmospheric pressure. Clearly, Aluminum and also Nickel (which is a favorite metal reactant of prior art dry reforming catalytic membranes) are inadequate according to the present invention method due to their high boiling temperatures.

If the reactions are operated at a pressure higher than atmospheric pressure then the preferred operational temperatures are respectively adjusted according to the metal reactant known boiling temperature at the higher pressure.

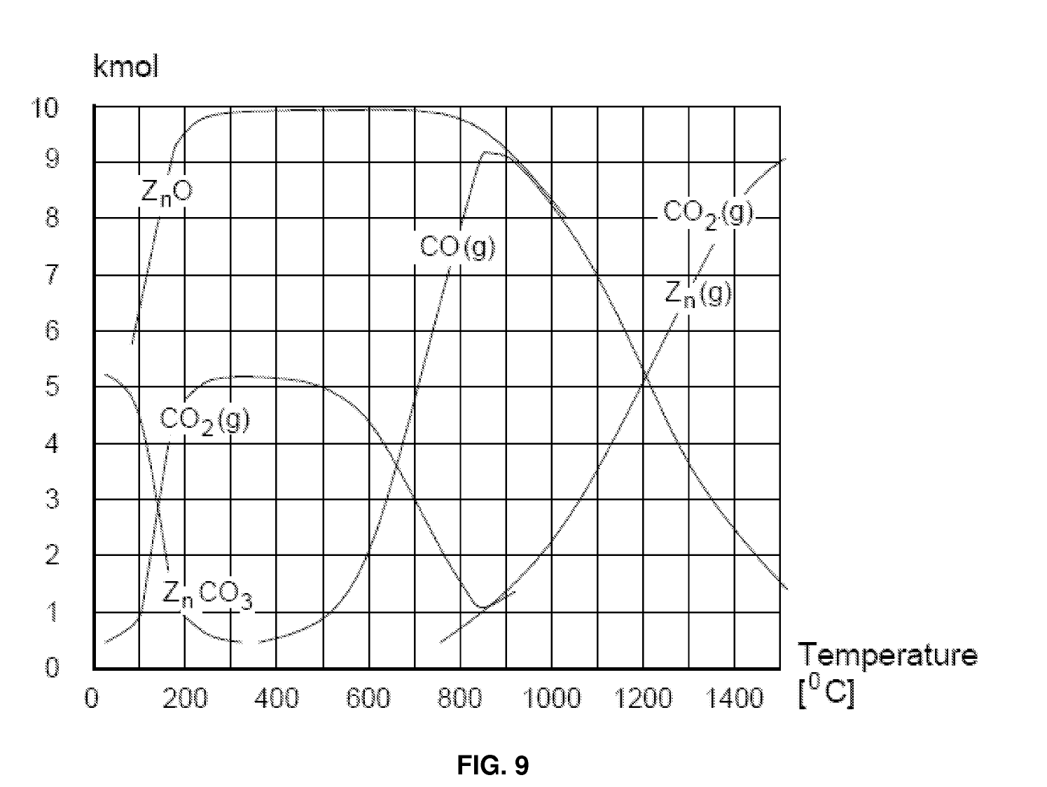

In some embodiments, according to the present invention, it may be useful to operate at a temperature near (i.e. within 160 degrees Celsius or within 100 degrees Celsius or within 90° C. or less), of the metal reactant boiling temperature. For example, this may be understood and exemplified by an analysis of the data presented in FIG. 9.

One potential advantage of working at near but below the boiling temperature is that the metal vapor pressure associated metal vapor density in the reaction chamber, is well controlled and can be fitted to the other gas ingredients densities.

In some embodiments some quantities of Zn (ort any other metal) flows out as gas in the mixture coming out from the reaction chamber, since significant Zn is in a vapor state in the reaction chamber. As illustrated in FIG. 3, in some embodiments, this Zn outflow may be returned back into the reaction.

For example, and as discussed earlier, separation of Zn from the other components of the gas outflow from the reaction chamber may be done by cooling of the outflow significantly below the Zn boiling temperature in a condenser (62), such that the metal vapor pressure is at least less than 0.1%. e.g., at 500° C. the Zn vapor pressure is less than 0.025%. Thereby, the Zn turns into liquid while the remaining components of the outflow rest in the gaseous state. The Zn liquid may be returned by first metal inlet (35) into the first reaction chamber.

In some embodiments, the condensed metal droplets coming out of condenser (62) are coalesced and demisted from the outflow in a demister (72) from which the liquid metal returned to the syngas producing unit (20) and the clean syngas is let out for further processing (e.g., to Methanol) or for storage.

Since heat is absorbed from the out flow in the condenser (62) and demister (72) units, in some embodiments heat exchangers from these units transfer the heat to other parts of the system, e.g. to heat the feedstock or to reheat the cleaned syngas outflow coming out of demister (72).

The simulations were carried out using a known commercial package named “HSC Chemistry for Windows”.

In some embodiments according to the present invention, the metal reactant is provided already in a gaseous state into the reaction chamber.

We further note that the above noted method of use of metal reactant vapors and associated advantages may be applied equally well to a method of steam reforming of natural gas in the presence of a metal reactant.

The present invention may be better understood with reference to the following scientific papers:

### LIST OF REFERENCES

[1] Moulijn, J., Makkee, M., van Diepen, A., Chemical Process Technology, John Wiley & Sons Ltd, England
[2] Dybkjaer, I., Tubular reforming and autothermal reforming of natural gas—an overview of available processes, Fuel. Proc. Tech., (1995).

The principles and operation of a method and a system for producing syngas according to the present invention may be better understood with reference to the drawings and the accompanying description.

Before explaining at least one embodiment of the invention in detail, it is to be understood that the invention is not limited in its application to the details of construction and the arrangement of the components set forth in the following description or illustrated in the drawings.

Unless otherwise defined, all technical and scientific terms used herein have the same meaning as commonly understood by one of ordinary skill in the art to which this invention belongs. The materials, dimensions, methods, and examples provided herein are illustrative only and are not intended to be limiting.

The following list is a legend of the numbering of the application illustrations:
20 syngas producing unit
25 carbon dioxide inlet
30 water inlet
31 methane inlet
35 first metal inlet (internal)
36 second metal inlet (external)
38 liquid metal sprinkling system
40 syngas outlet
42 gas flue
45 metal oxide outlet
50 fuel producing unit
52 external reactions chamber
60 metal regeneration unit
62 condenser
   70 power source
   72 demister
   74 gas detector
   91 first heat exchanger
   92 second heat exchanger
   93 metal casing
   94 ceramic insulator
   95 electric heater
   100 prior art system for producing syngas
   200 first embodiment of a system for producing syngas
   300 second embodiment of a system for producing syngas
   400 third embodiment of a system for producing syngas
   500 fourth embodiment of a system for producing syngas
   1000 method for producing syngas

The following list is specifies the markings used in the formulas and specification of the present the application.
Q Heat
kJ kilo Joule
mol Mole
bar standard barometric pressure
K degrees Kelvin
° C. degrees Celsius
ΔH enthalpy difference
ΔS₂₉₈ entropy difference at 298K
ΔH₂₉₈ enthalpy difference at 298K
ΔG₁₀₅₀ Gibbs free energy difference

In the following, some general features of exemplary embodiments of the invention are first outlined, and then, exemplary embodiments are described in detail.

FIG. 7 illustrates a plot of a numerical simulation of the reaction of some particular mixture (further elaborated on below) of natural gas, water (H₂O), and optionally carbon dioxide (CO₂), without any additional metal reactant. It shows the change in substances composition as a function of temperature.

FIG. 8 illustrates the results of computer simulation of the Case-II reaction with Zn metal reactant. It shows the change in substances composition as a function of temperature. Of particular note is the drop to near zero of the concentration of ZnO at the Zn boiling temperature. We conclude from it that in order to minimize the need for Zn regeneration from ZnO it is preferred to operate the reaction chamber very near the boiling temperature of Zinc.

FIG. 9 illustrates a plot of a simulation only for the catalytic reaction with Zinc;

Zn+CO₂→ZnO+CO. (19)

For the purpose of catalyzing the production of syngas, we are interested in maximal production of CO and reduction of CO₂. The plot in FIG. 6 shows that catalytic CO production is peaked between 850° C. and 910° C. CO production decreases by about 10% when operative temperature is either lowered to 800° C. or increased to 1,000° C.

FIG. 3 is a block diagram that schematically illustrates a first embodiment of a system for producing syngas 200, in accordance with an embodiment of the present invention, where there are no separate outlets from the syngas producing unit 20 for liquid metal and for syngas.

A flow of feedstock of methane (CH₄), water (H₂O), and optionally carbon dioxide (CO₂) is fed into the syngas producing unit 20, via carbon dioxide inlet 25, water inlet 30, and methane inlet 31, which can be maintained at any desired particular relative ratios.

The syngas producing unit 20, which is a reaction chamber contains a metal reactant. There is an optional external metal feeder (not shown on drawing). A gas flue 42 coming out of the syngas producing unit 20 contains both syngas and metal liquid droplets. The liquid droplets are separated in demister 72.

The liquid metal is then returned to the syngas producing unit 20 via first metal inlet 35, while the cleaned syngas that flows via syngas outlet 40 is then available for external storage or reactions such as methanol synthesis in fuel producing unit 50.

FIG. 10, is a block diagram that schematically illustrates a second embodiment of a system for producing syngas 300 in a non-limiting embodiment where there are no separate outlets from the syngas producing unit 20 for liquid metal and for syngas. A flow of feedstock of methane (CH₄), water (H₂O), and carbon dioxide (CO₂) is fed into the syngas producing unit 20, via carbon dioxide inlet 25, water inlet 30, and methane inlet 31, at particular relative ratios, (e.g., according to case-I or case-II noted in the present invention).

The syngas producing unit 20, which is a reaction chamber, contains a metal reactant. There is an optional external metal feeder (not shown in the present illustration). A gas flue 42 coming out of the syngas producing unit 20 may comprise syngas, metal vapor, and metal liquid droplets. The metal vapor component is condensed in condenser 62, which is operated at a lower temperature than the metal boiling temperature under the given pressure conditions. The resulting mixture of syngas and metal liquid droplets is transferred to demister 72. The liquid droplets are separated in the demister 72, e.g. by a demister. The liquid metal is then returned to the syngas producing unit 20 via first metal inlet 35, while the cleaned syngas that flow via syngas outlet 40 is then available for external reactions such as methanol synthesis in external reactions chamber 52.

FIG. 11, is a block diagram that schematically illustrates a third embodiment of a system for producing syngas 400, in accordance with an embodiment of the present invention, where there are separate outlets from the syngas producing unit 20 for metal oxide outlet 45, and for 42. A flow of feedstock of methane (CH₄), water (H₂O), and carbon dioxide (CO₂) is fed into the syngas producing unit 20, via carbon dioxide inlet 25, water inlet 30, and methane inlet 31, at particular relative ratios, (e.g., according to case-I or case-II or case-III noted in the present invention).

In the non-limiting example, metal is fed into the syngas producing unit 20, via second metal inlet 36.

The syngas producing unit 20 may also include a liquid metal sprinkling system 38.

The syngas producing unit 20, which is a reaction chamber contains a metal reactant. There is an optional external metal feeder (not shown on drawing). From metal oxide outlet 45, the liquid metal oxide (e.g., ZnO) goes into a metal regeneration chamber 60 for conversion into pure metal (e.g., Zn). The gas flue 42 coming out of the syngas producing unit 20 may comprise syngas, metal vapor and metal liquid droplets. The metal vapor component is condensed in condenser 62, which is operated at a lower temperature than the metal boiling temperature under the given pressure conditions. The resulting mixture of syngas and metal liquid droplets is transferred to demister 72. The liquid droplets are separated in demister 72. The liquid metal is then returned to the syngas producing unit 20 via first metal inlet 35, while the cleaned syngas flow via syngas outlet 40 is then available for external reactions such as methanol synthesis in external reactions chamber 52. The liquid metal coming out of the metal regeneration unit 60 is also returned into the syngas producing unit 20, preferably by combining it with the liquid metal flow coming out of the demister 72.

FIG. 12 is a block diagram that schematically illustrates a fourth embodiment of a system for producing syngas 500, in accordance with an embodiment of the present invention, where there are separate outlets from the syngas producing unit for metal oxide outlet, and for gas flue.

In addition, for the present invention method of using vapor of metal reactant, there is a need and an advantage to a step of condensing the metal vapor to a liquid state, performed within a condensation chamber part of a condenser 62, prior to the demisting stage of the process in demister 72. In an embodiment of the present invention, in order to sufficiently reduce the metal vapor content, it is preferred operate the condensation unit such that the exhaust products temperature is lowered to at least 300° C. below the boiling temperature of the metal at the operational pressure of the condensation chamber.

In an embodiment of the present invention, heat is recovered from condenser 62, e.g., by heat exchangers, and delivered to other parts of the system (e.g., for heating the feedstock).

Another embodiment of a system for producing syngas 500 is based on a ceramic structure capable to withstand 1,100° C. and is inert to liquid Zinc or Zinc oxide. At least part of this embodiment, a system for producing syngas 500 is surrounded by layers of insulating material selected for minimum thermal content. The entire structure is located within a metal casing in order to allow extended pressure operation. The temperature of the metal casing is controlled with the aid of the incoming reaction components. In this embodiment, a system for producing syngas 500 may be equipped with pressure sensor and temperature sensors, (not shown in the present illustration). Heating a heater such as electric heater 95 supplies additional heat energy into the reaction chamber, the syngas producing unit 20. Gas inlet valves and flow sensors control the composition and flow rate of the various reactants comprising of feedstock gasses and metal reactant. At the exit of condenser 62 there is a first heat exchanger 91 that reduces the temperature of the product gases to around 500° C. which is above the temperature of melting of Zinc but with very low vapor pressure.

In this embodiment, the condenser 62 is located above the syngas producing unit 20, thereby some fraction of the condensed metal can fall back under the force of gravity into the syngas producing unit 20. The product gases continue to flow to a passive droplets and particles separator, the demister 72 that returns the separated liquid into the syngas producing unit 20. The product gases continue into a second heat exchanger 92 that reduces the temperature to a value that corresponds to the next chemical reaction. The cooled gas products are directed into a set of gas detectors 74 to analyze their composition. All information is directed to a central control system that controls also the valves, the electric heaters, and the temperature of the heat exchangers. The thermal energy removed by the heat exchangers.

FIG. 13 is a flow chart that schematically illustrates a method for producing syngas 1000, in accordance with a particular non-limiting embodiment of the present invention.

The method may includes any number of the following stages:
stage A, providing a feedstock of ingredients into a syngas producing unit, wherein the ingredients includes CH₄ and at least one ingredient is selected from a group consisting of H₂O and CO₂;
stage B, providing a feedstock of at least one metal reactant into the syngas producing unit;
stage C, reacting, in the syngas producing unit, a mixture of the feedstock ingredients with the metal reactant;
stage D, demisting by letting out products of a reaction, wherein the products of the reaction include syngas and metal reactant, into a demister, and separating liquid of the metal from the products syngas;
stage E, recycling the metal by returning the liquid metal from the demister into the syngas producing unit; and
stage F, transferring remaining gaseous products from the syngas producing unit into fuel producing unit.
stage G, maintaining a temperature of the syngas producing unit within 90° C. from the boiling temperature of the metal at a pressure in which the reaction is operated within the syngas producing unit, and thereby creating a significant portion of vapor of the metal;
stage H, letting out products of the reaction into a condenser;
stage I, condensing the vapor of the metal by cooling gas products within the condenser to a cooled temperature, wherein the cooled temperature is least 300° C. below the metal boiling temperature, so that the metal is liquefied while remaining products are maintained in a gaseous state, wherein the remaining products includes CO, H₂, H₂O, CO₂ and CH₄; and
stage J, letting out all products of the condenser into the demisting demister.

There are several options for determining the working parameters according to the method of the present invention, also including in various combinations that:
the metal is selected from a group consisting of a first metal having a boiling temperature within 100° C., from 1000° C. at atmospheric pressure, and a second metal having a boiling temperature within 200° C., from 1000° C. at atmospheric pressure.
the syngas producing unit temperature is selected from a group consisting of a temperature within 80° C., a temperature within 70° C., a temperature within 60° C., a temperature within 50° C., a temperature within 40° C., a temperature within 30° C., 20° C., and a temperature within 10° C. of the boiling temperature of the metal at the pressure in which the reaction is operated within syngas producing unit.
a reaction of the metal reactant with the feedstock ingredients includes reacting H₂O with the metal to obtain H₂, metal-oxide and heat, reacting CO₂ with the metal, to obtain CO, metal-oxide and heat, and reacting CH₄ with the metal-oxide to obtain the metal, CO, and two H₂.
the metal reactant is selected from a group consisting of Zinc, Magnesium, Cadmium, and Strontium.
the cooled temperature is selected from a group consisting of a temperature within 300° C. to 400° C., a temperature within 400° C. to 500° C., and a temperature within 500° C. to 600° C., from the metal boiling temperature at the pressure of operation of the condenser.
a ratio of the feedstock ingredients of CH₄ to H₂O to CO₂ is maintained at near 3 to 2 to 1 within a deviation that is selected from a group consisting of at most 10% deviation, at most 5% deviation, and at most 1% deviation.
a ratio of the feedstock ingredients of CH₄ to H₂O to CO₂ is maintained at near 1 to 2 to 1 within a deviation that is selected from a group consisting of at most 10% deviation, at most 5% deviation, and at most 1% deviation.
a ratio of the feedstock ingredients of CH₄ to H₂O to CO₂ is maintained at near 1 to 1 to 0 within a deviation that is selected from a group consisting of at most 10% deviation, at most 5% deviation, and at most 1% deviation.
the demister temperature is maintained at above the boiling temperature of water.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination.

Although the invention has been described in conjunction with specific embodiments thereof, it is evident that many alternatives, modifications and variations of these embodiments will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

The terms “recycle” and “regenerate” are used in the present description and claims interchangeably.

While the invention has been described with respect to a limited number of embodiments, it will be appreciated that many variations, modifications and other applications of the invention may be made.

1. A method of syngas production comprising:
chemically reacting a reaction mixture of CH₄, H₂O and vapor of a metal to produce syngas substantially without net production of a non-transient oxide of the metal.

2. The method of claim 1 wherein the reaction mixture further includes CO₂.

3. (canceled)

4. The method of claim 2 wherein the mole-ratio value is at most 0.01.

5. The method of claim 2 wherein the mole-ratio value is at most 0.001 or at most 0.0001.

6-28. (canceled)

29. A method of syngas production comprising:
Effecting an industrial process where:
i) a gas mixture of CH₄, CO₂, H₂O and metal vapor is chemically reacted to produce syngas;
ii) substantially all metal oxide that is produced during the chemical reaction is regenerated back into non-oxidized metal; and
iii) the combination of the syngas production and the metal regenerating is net CO₂-consuming.

30. The method of claim 29 wherein the combination of the syngas production and the metal regenerating is consumed at least 0.15 moles of CO₂ for every mole of CO generated.

31-67. (canceled)

68. A method of syngas production comprising:
a. providing a flow of CH₄, H₂O and optionally carbon dioxide to a reaction chamber at a fixed input ratio;
b. within the reaction chamber, chemically reacting a reaction mixture of vapor of a metal, CH₄, H₂O and optionally carbon dioxide of a metal to produce syngas wherein a quantity of oxide of the metal produced by the chemical reaction is not proportional to the flow rate of the CH₄ and/or H₂O.

69. The method of claim 68 wherein doubling the input gas flow rate of CH₄ and/or H₂O does not increase the rate of production of the oxide of the metal and/or increases the rate of production by less than 50%.

70. The method of claim 69 wherein it increase the rate of production by less than 20%.
